(19) United States
(12) Patent Application Publication
(10) Pub. No.: US 2014/0204728 A1
(43) Pub. Date: Jul. 24, 2014

(54) NODE EQUIPMENT AND METHOD FOR COMMUNICATION

(71) Applicant: FUJITSU LIMITED, Kawasaki-shi (JP)

(72) Inventors: Toshitsugu Kobayashi, Fukuoka (JP); Yoshinobu Shimokawa, Itoshima (JP); Satoshi Hamanaka, Fukuoka (JP); SYOICHI URATA, Fukuoka (JP); Kenji MAEDA, Kasuga (JP); YOSHIYUKI JUFUKU, Itoshima (JP); Yasunori Murata, Fukuoka (JP); YUZURU SHIMOMURA, Fukuoka (JP)

(73) Assignee: FUJITSU LIMITED, Kawasaki-shi (JP)

(21) Appl. No.: 14/219,353

(22) Filed: Mar. 19, 2014

Related U.S. Application Data
(63) Continuation of application No. PCT/JP2011/071401, filed on Sep. 20, 2011.

(51) Int. Cl. H04L 12/733; H04L 12/24; H04L 12/705; H04L 12/741

(52) U.S. Cl. CPC H04L 45/122; H04L 45/745; H04L 41/0668; H04L 45/18
USPC 370/218; 370/392

(57) ABSTRACT

A node equipment includes a receiver, a processor, a memory and a transmitter. The node equipment is relayed by a plurality of relay devices with a server. The receiver receives a frame from adjacent node equipment. The processor generates a wait number by incrementing a number of hops for each of the relay devices, when the number of hops to the adjacent node equipment is reported with a synchronization request, the number of hops being generated by designating each of the plurality of relay devices as a starting point. The memory stores the wait number in association with an identifier of the relay device. The transmitter transmits a data frame in which the server is designated as an address. The processor outputs to the transmitter a data frame in which a relay device having a relatively small wait number stored in the memory is designated as a relay destination.

### CROSS-REFERENCE TO RELATED APPLICATION

This application is a continuation application of International Application PCT/JP2011/071401 filed on Sep. 20, 2011 and designated the U.S., the entire contents of which are incorporated herein by reference.

### FIELD

The embodiments discussed herein relate to a communication in a network which includes a plurality of node equipment.

### BACKGROUND

As an example of an autonomous distributed network, a wired ad hoc network is exemplified. A wired ad hoc network is sometimes applied, for example, to a sensor network. In this case, an individual sensor which forms an ad hoc network may be embedded in structural objects such as buildings, bridges, and the like, and further, it may be installed in locations such as in soil or in water where installations of a wireless network are difficult. The wired ad hoc network also has an advantage in that a disconnection due to an occurrence of a problem is easily detected, since a data transmission and reception is performed through a cable.

In configuring the ad hoc network, technologies that include path selections, controls when a problem occurs, and the like are also required. As an example for path selections, a method of selecting a path including setting a group ID in each gateway and node equipment in the network beforehand, and each piece of node equipment selecting a path that has a best communication quality from among the paths which reach a gateway to which the same group ID is assigned is known. In addition, a method for detecting a loop is also devised. In this method, first node equipment transmits from a first port a first frame, and at the same time, stores information for determining a first port and first identification information for identifying a first frame by associating both pieces of information. When first node equipment receives a second frame from second node equipment, the first node equipment compares second identification information for identifying a second frame with first identification information, and when both are matched, the first node equipment judges that a loop has been detected. Further, a method is also known in which a mobile terminal communicates with an external network via one gateway node that was selected by a path search, and when the mobile terminal receives a notification that a path has been disconnected during a communication, it searches for a path again to select a gateway node. The mobile terminal continues a communication with the external network via a newly selected gateway node.

Japanese Laid-open Patent Publication No. 2009-77119, International Patent Application Publication No. 2010/131288, International Patent Application Publication No. 2006/048936, and the like are known.

When a gateway is selected by methods mentioned in the background art, in some cases, a gateway having a smallest number of hops is not selected from node equipment, and due to a large number of hops to the selected gateway, a path has frequently been made redundant. Further, in methods for selecting a path mentioned in the background art, a path having a smallest number of hops is not selected for a path to the selected gateway, either, and a redundant path may sometimes be selected.

### SUMMARY

According to an aspect of the embodiments, a node equipment includes a receiver, a processor, a memory and a transmitter. The node equipment configured to be relayed by a plurality of relay devices with a server in a network. The receiver receives a frame from adjacent node equipment. The processor generates a wait number that is generated by incrementing a number of hops for each of the relay devices, when the number of hops to the adjacent node equipment is reported together with a synchronization request from the adjacent node equipment, the number of hops for each of the relay devices being generated by designating each of the plurality of relay devices as a starting point. The memory stores the generated wait number in association with an identifier that identifies the relay device. The transmitter transmits a data frame in which the server is designated as an address. The processor outputs to the transmitter a data frame in which a relay device having a relatively small wait number stored in the memory is designated as a relay destination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a network according to an embodiment.

FIG. 2 illustrates an example of a configuration of a sensor relay node.

FIG. 3 illustrates an example of a configuration of a routing control unit.

FIG. 4 illustrates an example of a wait number table.

FIG. 5 illustrates an example of a node management table.

FIG. 6 illustrates an example of a network and an example of a wait number decision.

FIG. 7 explains an example of a format of a frame.

FIG. 8 illustrates an example of a wait number table.

FIG. 9 illustrates an example of a wait number table.

FIG. 10 illustrates an example of a relay destination decided at each sensor relay node.

FIG. 11 illustrates an example of a table stored by a core relay node.

FIG. 12 illustrates an example of a wait number table.

FIG. 13A is a flowchart which explains an example of an operation of a sensor relay node when receiving a frame.

FIG. 13B is a flowchart which explains an example of an operation of a sensor relay node when receiving a frame.

FIG. 13C is a flowchart which explains an example of an operation of a sensor relay node when receiving a frame.

FIG. 13D is a flowchart which explains an example of an operation of a sensor relay node when receiving a frame.

FIG. 13E is a flowchart which explains an example of an operation of a sensor relay node when receiving a frame.

FIG. 13F is a flowchart which explains an example of an operation of a sensor relay node when receiving a frame.

FIG. 14 is a flowchart which explains an example of an operation of a selection unit when selecting a core relay node of a relay destination.

FIG. 15 illustrates an example of when a problem occurs on a line between a core relay node and a server.

FIG. 16 illustrates an example of a relay destination decided at each sensor relay node.

FIG. 17 illustrates an example of changing a core relay node of a relay destination when a problem of a core relay node is found.

FIG. 18A to FIG. 18C explain an example of an initialization of a wait number.

FIG. 19 A to FIG. 19D explain an example of an initialization of a wait number.

FIG. 20A to FIG. 20C explain an example of an initialization of a wait number.

FIG. 21A to FIG. 21B explain an example of an initialization of a wait number.

FIG. 22 explains an example of an initialization of a wait number.

FIG. 23 explains an example of a change of a wait number.

FIG. 24A is a flowchart which explains an example of an operation of a sensor relay node when an adjacent sensor relay node has failed.

FIG. 24B is a flowchart which explains an example of an operation of a sensor relay node when an adjacent sensor relay node has failed.

FIG. 25 illustrates an example of a table stored by a core relay node.

FIG. 26 illustrates an example of when await number has been re-decided.

FIG. 27 illustrates an example of when await number has been re-decided.

FIG. 28 is a flowchart which explains an example of an operation of a sensor relay node in a fifth embodiment.

FIG. 29 is a flowchart which explains an example of an operation of a core relay node in a fifth embodiment.

FIG. 30 is a flowchart which explains an example of an operation of a selection unit when selecting a core relay node of a relay destination.

FIG. 31 is a flowchart which explains an example of an operation of a sensor relay node.

### DESCRIPTION OF EMBODIMENTS

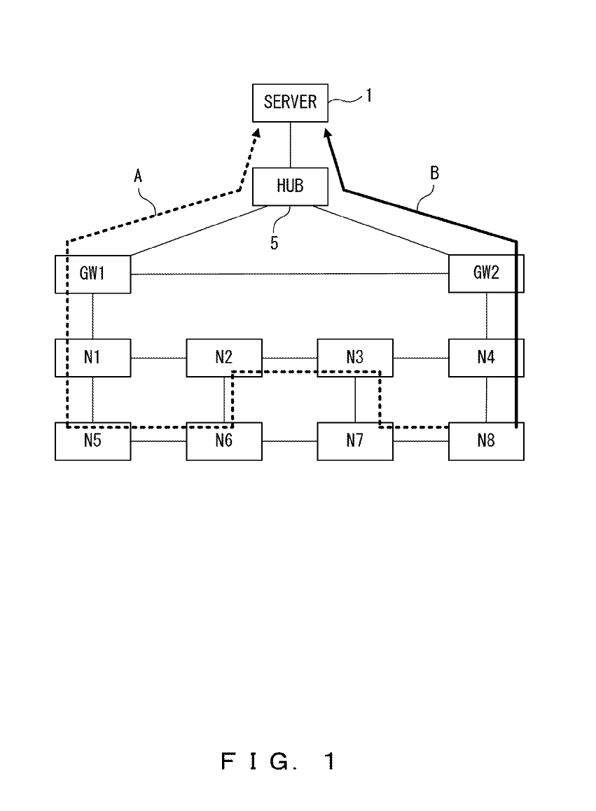

FIG. 1 illustrates an example of a network according to an embodiment. A network illustrated in FIG. 1 includes eight pieces of node equipment that consists of nodes N1 to N8, an ad hoc network which includes two gateway apparatuses that are gateways GW1 and GW2, a hub 5, and a server 1. A server 1 transmits and receives a frame to and from node equipment via a hub 5 and a gateway apparatus. In the following explanations, it is presupposed that individual node equipment that is included in the ad hoc network stores a path to adjacent node equipment or to a gateway but that it does not store a path to other equipment that is included in the network.

Node equipment determines a number of hops from a GW1 to node equipment and a number of hops from a GW2 to node equipment, by transmitting and receiving to and from the adjacent node equipment a frame which includes a number of hops from the gateway apparatus. For example, since a node N4 is adjacent to a gateway GW2, the node N4 reports to nodes N3 and N8 that the number of hops from the gateway GW2 is 1. Then, the nodes N3 and N8 that are adjacent to the node N4 recognize that the number of hops from the gateway GW2 is 2 and report the number of hops to respective adjacent nodes.

In the following explanations, a smallest value of the number of hops from any of the gateway apparatuses to node equipment may be called “a wait number”. For example, since a node N4 is adjacent to a gateway GW2, a wait number of the node N4 in which the gateway GW2 is designated as a starting point is 1. Further, since a node N8 is adjacent to a node N4, a wait number of the node N8 in which the gateway GW2 is designated as a starting point is 2. On the other hand, one of the shortest paths from the gateway GW1 to the node N8 is a path which reaches from the GW1 through N1, N2, N3, and N7 to N8. Accordingly, a wait number of the node N8 in which the gateway GW1 is designated as a starting point is 5.

The node equipment specifies as a relay destination to a server 1 a gateway apparatus having a smallest wait number, when it transmits a frame to a server 1. For example, when a node N8 transmits a frame to a server 1, the node equipment compares await number (=2) of the node N8 in which the gateway GW2 is designated as a starting point with a wait number (=5) of the node N8 in which the gateway GW1 is designated as a starting point. Here, a wait number in which the gateway GW2 is designated as a starting point is smaller than the wait number in which the gateway GW1 is designated as a starting point. Accordingly, the node N8 specifies the gateway GW2 as a relay destination. This prevents a frame which was transmitted from the node N8 from being transmitted to a server 1 by a redundant path as illustrated by an arrow (A) in a dashed line of FIG. 1, for example.

As mentioned above, since each node included in an ad hoc network accesses a server 1 through a gateway apparatus that may be reached with a smallest number of hops, a path to a server 1 may be shortened.

Further, in transferring a frame addressed to a server 1, an individual node selects as a transfer destination a node having a small wait number in which a gateway apparatus of a relay destination is designated as a starting point. For example, a frame that was transmitted from the node N8 by specifying the gateway GW2 as a relay destination is transmitted to the gateway GW2 when it is transmitted to the node N4. However, when it is transmitted to the node N7, a frame is not transmitted to the gateway GW2, but it is sent back to the node N8, since a wait number (=3) of the node N7 in which the gateway GW2 is designated as a starting point is larger than a wait number (=2) of the node N8 in which the gateway GW2 is designated as a starting point. Therefore, the frame which is transmitted from the node N8 to the server 1 is transmitted to the server 1 through a shortest path, as illustrated by an arrow (B) in a solid line of FIG. 1.

<Configuration of Equipment>

In the following examples, it is presupposed that node equipment includes a sensor and that the node equipment is equipment (sensor relay node 10) which relays a frame to be transmitted from other node equipment to a server 1. On the other hand, it is presupposed that a gateway apparatus does not include a sensor and the gateway apparatus is an apparatus (core relay node) which relays a frame that was received from the node equipment.

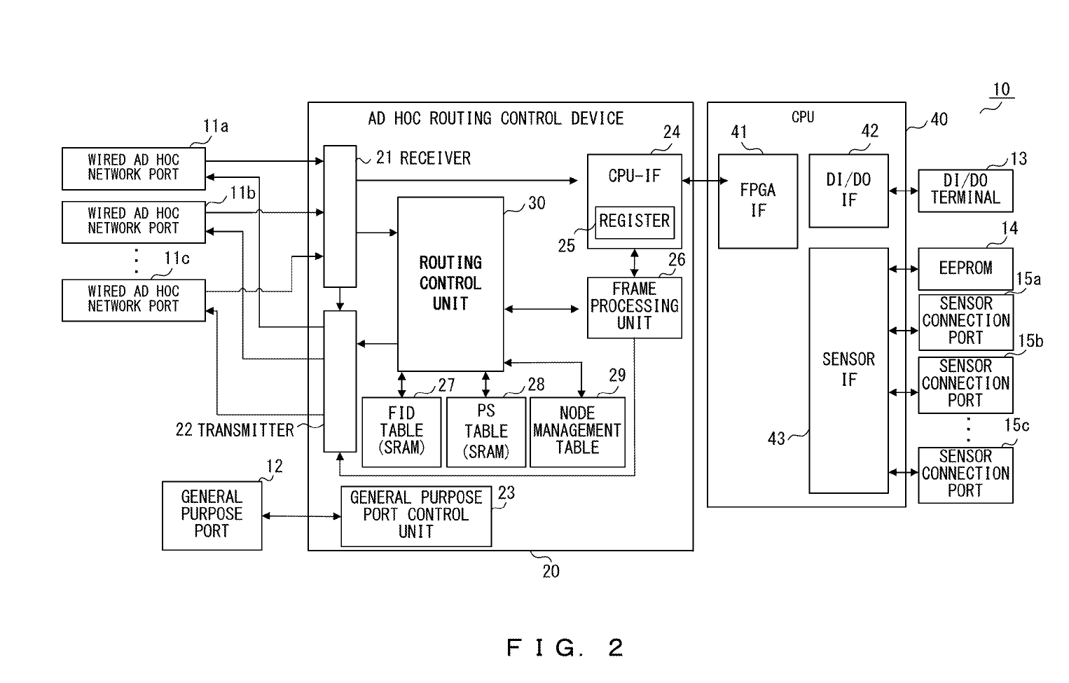

FIG. 2 illustrates an example of a configuration of a sensor relay node 10. A sensor relay node 10 includes wired ad hoc network ports 11 (11a to 11c), a general-purpose port 12, an ad hoc routing control device 20, and a Central Processing Unit (CPU) 40. The node equipment further includes a digital input/digital output (DI/DO) terminal 13, Electrically Erasable and Programmable Read Only Memory (EEPROM) 14, and sensor connection ports 15 (15a to 15c).

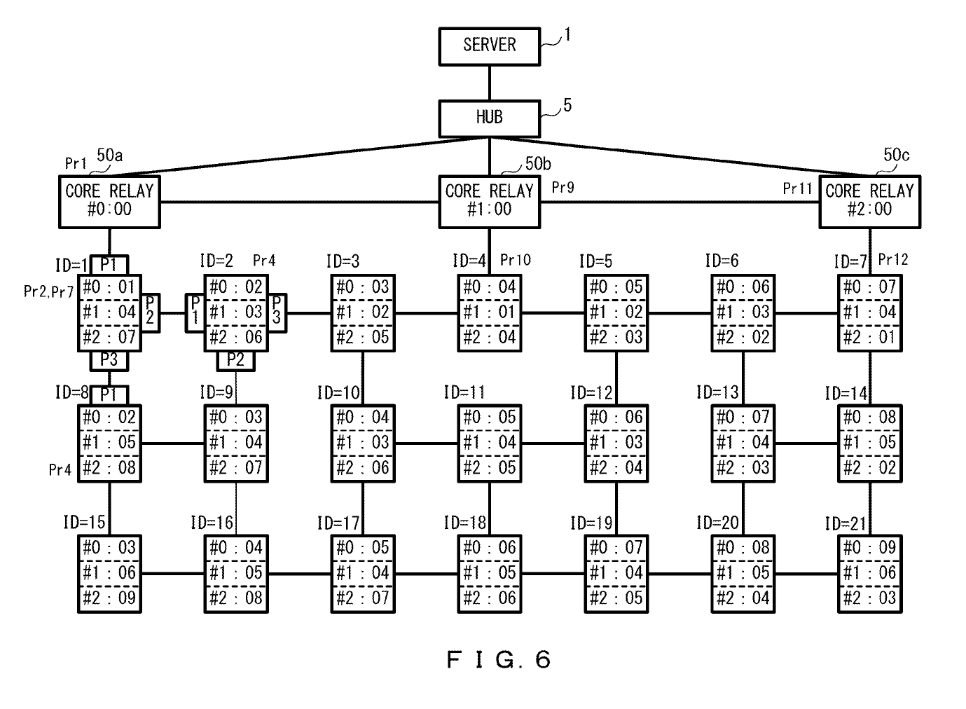

A wired ad hoc network port 11 terminates a piece of data of an Ethernet frame in which the ad hoc frame that is transmitted and received with another sensor relay node 10 or a core relay node 50 (see FIG. 6) is encapsulated and encodes or decodes transmitted/reception frames. Although the number of ad hoc network ports 11 that are included in the sensor relay node 10 is arbitrary, in the following explanation, a case in which the sensor relay node 10 includes three ports P1, P2, and P3 is explained as an example. The ad hoc network port 11 may include a buffer memory which temporarily stores a transmitted frame. In the following descriptions, the ad hoc network port 11 may sometimes be described as “a port” or “a reception port” as well. A general purpose port 12 terminates a LAN (Local Area Network), for example.

An ad hoc routing control device 20 is realized, for example, by a processor such as an FPGA (Field Programmable Gate Array) and the like or by a memory such as an SRAM (Static Random Access Memory) and the like. The ad hoc routing control device 20 includes a receiver 21, a transmitter 22, a general purpose port control unit 23, a CPU interface 24, a frame processing unit 26, and a routing control unit 30. The ad hoc routing control device 20 further includes an FID (Frame ID) table 27, a PS (Port Status) table 28, and a node management table 29. The FID table 27, the PS table 28, and the node management table 29 are stored in a memory (not illustrated). The processor realizes the receiver 21, the transmitter 22, the general purpose port control unit 23, the CPU interface 24, the frame processing unit 26, and the routing control unit 30. In addition, the CPU interface 24 has a register 25.

A receiver 21 receives frame data from wired ad hoc network ports 11a to 11c. The receiver 21 outputs to a routing control unit 30 a frame in which an address is another sensor relay node 10. When the address of a frame is a local node, the receiver 21 outputs a frame to a CPU interface 24. A CPU interface 24 outputs to a CPU 40 a frame which was input from the receiver 21. A CPU interface 24 appropriately uses a register 25 when it outputs a frame to the CPU 40.

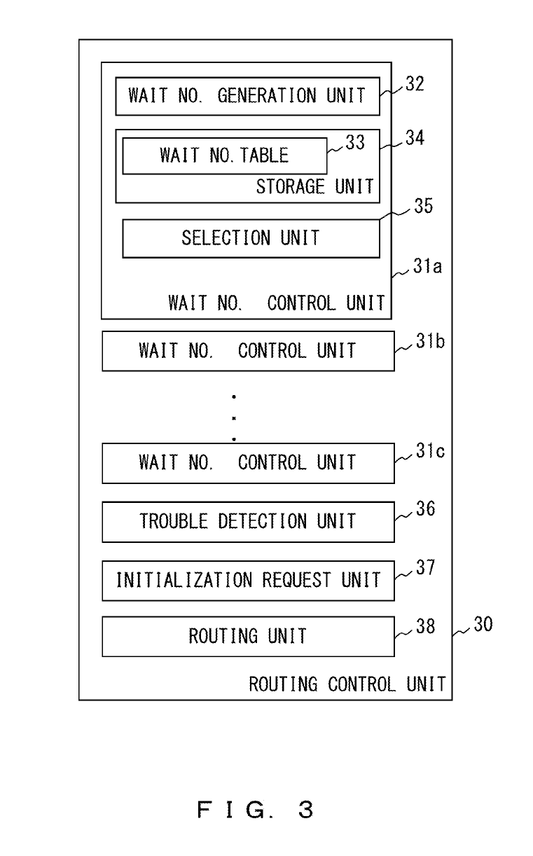

A routing control unit 30 performs routing processing which uses a wait number. An example of a configuration of a routing control unit 30 is illustrated in FIG. 3. A routing control unit 30 includes wait number control units 31 (31a to 31c), a problem detection unit 36, an initialization request unit 37, and a routing unit 38. A wait number control unit 31a includes await number generation unit 32, a storage unit 34, and a selection unit 35, and has a wait number table 33 in a storage unit 24. Wait number control units 31a to 31c are configured to process wait numbers in which different core relay nodes 50 are designated as starting points. For example, a wait number control unit 31a processes a wait number in which a core relay node 50a is designated as a starting point, and a wait number control unit 31b processes a wait number in which a core relay node 50b is designated as a starting point. Although details for wait number control units 31b and 31c are not illustrated in FIG. 3 simply for ease of viewing FIG. 3, both wait number control units 31b and 31c are configured similar to the wait number control unit 31a. A wait number generation unit 32 decides a wait number which is assigned to a sensor relay node 10 in which the wait number generation unit 32 is included, by incrementing the wait number included in a frame that was received from an adjacent sensor relay node 10.

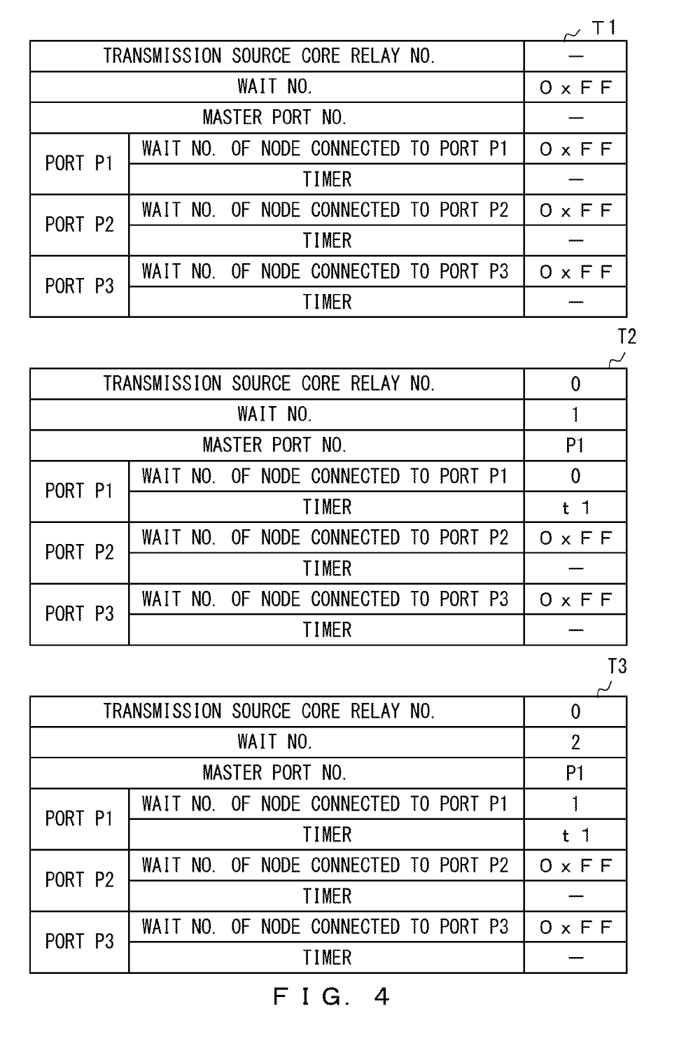

T1 of FIG. 4 illustrates an example of a wait number table 33. An example illustrated in T1 of FIG. 4 is a wait number table 33 in an initialized state, and data is not recorded in the wait number table 33. The wait number table 33 stores a wait number decided by a wait number generation unit 32 and a wait number of a sensor relay node 10 that was connected via each of the ports P1 to P3. At this time, the wait number generation unit 32 stores a wait number in association with an identifier (a transmission source core relay number) that identifies a core relay node 50 that was used as a reference position in deciding the wait number. Further, a port number of a port that received a frame used for deciding the wait number is also recorded in the wait number table 33. Hereafter, a port that received a frame used for deciding the wait number may be called “a master port”. Although FIG. 3 illustrates one wait number table 33, a number of the wait number tables 33 that is the same as the number of core relay nodes 50 which is included in a network is provided. An individual wait number table 33 is configured to store information on a wait number when a core relay node 50 is designated as a starting point.

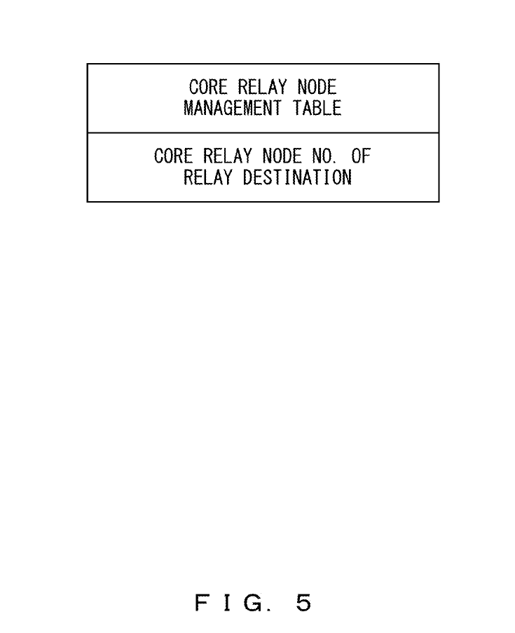

A selection unit 35 uses a wait number table 33 to decide a core relay node 50 which is designated as a relay destination when transmitting a frame to a server 1. In addition, a selection unit 35 records a selected result in a node management table 29. An example of a node management table 29 is illustrated in FIG. 5. In the example of FIG. 5, although an identifier which identifies a core relay node 50 that was selected at the selection unit 35 is recorded in the node management table 29, any other information may also be included in the node management table 29 in accordance with implementations. Detailed explanations for a method for generating or using a wait number table 33 and an operation of a selection unit 35 will be given later.

A problem detection unit 36 monitors a status of an adjacent sensor relay node 10, and when a problem occurs in a communication with the adjacent sensor relay node 10, it detects the occurrence of a problem. A problem detection unit 36 reports to an initialization request unit 37 that the problem has occurred. An initialization request unit 37 specifies a wait number that changes when a problem occurs and initializes the specified wait number. Further, the initialization request unit 37 appropriately requests of the adjacent sensor relay node 10 the initialization of the wait number. Detailed explanations for operations of a problem detection unit 36 and an initialization request unit 37 will be given later.

A routing unit 38 specifies a port of a transfer destination of a frame that was input from the receiver 21 to the routing control unit 30. A routing unit 38 refers to a PS table 28, an FID table 27, and a wait number table 33 and decides a port of a transfer destination. Here, a PS table 28 is a table which stores a frame-transferable port for each address. The PS table 28 may be configured to have an arbitrary format in which a port number to which a frame may be transferred is associated with a destination address of the frame. A routing unit 38 outputs to a transmitter 22 a frame to be transferred, together with information which reports the port number of the transfer destination.

An FID table 27 is used for detecting a loop. An FID table 27 records a use status of a wired ad hoc network port 11 in association with a combination of a transmission source address of a frame that has been received and a value of an FID field. A use status of the wired ad hoc network port 11 indicates connection information of each loop, such as no link from a wired ad hoc network port 11 (link disconnection), looped (loop state), unused, being used for transmitting a frame to an address (port under transmission), and the like. A use status of the wired ad hoc network port 11 is decided in accordance with a combination of a transmission source address of a frame and a value of an FID field. For example, suppose that a frame address of FID=1 transmitted from a node N1 is a node N4. When a frame is transmitted from a port P1 of a node N2 to a node N4, a use status that is associated with a node N1 as a transmission source and a frame of FID=1 becomes “a port under transmission” in a port P1 of a node N2. On the other hand, suppose that a frame address of FID=2 transmitted from a node N1 is a node N5. It is further presupposed that due to an occurrence of a loop, a node N2 receives a transmitted frame again from other node equipment, even when a frame is transmitted from the port P1 of the node N2 to a node N5. In this case, a use status that is associated with a node N1 as a transmission source and a frame of FID=2 becomes “a loop state” in a port P1 of the node N2. Further, in the port that has a node N1 as a transmission source and in which no frame of FID=1 has been transmitted, the use state associated with a node N1 as a transmission source and a frame of FID=1 becomes “unused”.

Further, an FID table 27 includes one Loop flag for each entry. Here, a Loop flag indicates whether or not a local node exists on a path leading to a node of an address of a frame specified by a combination of a transmission source address and an FID that are recorded in an entry. When a Loop flag=1, this indicates that a local node does not exist on a path leading to a node of an address of a frame specified by a combination of a transmission source address and an FID that are recorded in an entry. In other words, that a Loop flag=1 indicates that the local node does not transfer the frame to the address of the frame. On the other hand, when a Loop flag=0, this indicates that a local node exists on a path leading to a node of an address of a frame specified by a combination of a transmission source address and an FID that are recorded in an entry. In other words, that a Loop flag=0 indicates that the local node may transfer the frame to the address of the frame.

A routing unit 38, before transferring the frame, checks whether or not a combination of a transmission source address and an FID field value matches up with any of the entries of the FID table 27. When the combination matches up with the entry in the FID table 27, a routing unit 38 judges that it has received the already received frame and it does not transfer a frame. At this time, the routing unit 38 associates with the combination of a transmission source address of a frame and a value of an FID field and records that it does not transfer a frame to the address of the frame. For example, a routing unit 38 provides a Loop flag for each entry and when it detects a loop, sets a Loop flag of a corresponding entry as “1”. Then, for a frame that includes a combination of a transmission source address and an FID recorded in an entry at which a Loop flag is set as 1, a routing unit 38 does not perform a transfer but sends back a frame from a port which received the frame. On the other hand, when there is no matching entry in an FID table 27, a routing unit 38 searches a PS table 28 by setting an address of a frame as a key. When the address of the frame is recorded in the PS table 28, the routing unit 38 transfers a frame by making the frame be output from the port that is designated as a PS table 28.

A routing unit 38 may further decide a transfer destination by using a wait number assigned to a node of the address of a frame to be transferred and a wait number assigned to a local node. When the wait number assigned to an address of a frame is larger than a wait number of a local node, a routing unit 38 transfers a frame which is a transfer target from a port connected to a node to which a wait number that is larger than that of a local node is assigned. On the other hand, when there is no port connected to a node to which a wait number that is larger than that of a local node is assigned, a routing unit 38 judges that it has detected a loop. Then, the routing unit 38 sends back a frame to node equipment of a transmission source by sending back the frame from the port that received the frame. When the loop is detected, on the basis of an address of a transmission source of a frame which was set as a transmission target and a value of an FID field, a use status of the port in the FID table 27 is changed to “a loop state”.

Next, explanations are given for an operation of a routing unit 38 when a wait number assigned to an address of a frame is smaller than await number of a local node. In this case, a routing unit 38 transfers a frame which is a transfer target from a port connected to node equipment to which await number that is smaller than that of a local node is assigned. When there is no port connected to node equipment to which a wait number that is smaller than that of a local node is assigned, a routing unit 38 judges that it has detected a loop. When detecting the loop, a routing unit 38 sends back a frame of a processing target to node equipment which is a transfer source. Further, information on a port of the FID table 27 is updated.

When a wait number assigned to an address of a reception frame matches up with await number of a local node, the node equipment checks whether or not the address of a frame is the local node. When the address of a frame is the local node, the reception frame is appropriately processed by a CPU 40 or the like. On the other hand, when the address of a frame is not the local node and when a wait number assigned to the address of the reception frame matches up with the wait number of the local node, a routing unit 38 judges that it has detected a loop. The processing performed when detecting the loop is as mentioned above.

A frame processing unit 26 generates a frame which includes information obtained by a CPU interface 24 from a CPU 40 and outputs the frame to a routing control unit 30 or a transmitter 22. A transmitter 22 outputs the frame that was input from the routing control unit 30 or the transmitter 22 to a wired ad hoc network port 11 in accordance with a transmission destination.

A CPU 40 processes information that was obtained from a sensor (not illustrated) included in a sensor relay node 10. The CPU 40 includes an FPGA interface 41, a DI/DO interface 42, and a sensor interface 43. An FPGA interface 41 is a circuit which performs a transmission/reception of sensor information and sensor control information and the like to and from the CPU interface 24. A sensor interface 43 is a circuit which performs a transmission/reception of information to and from a sensor via a sensor connection port 15. Here, as the sensor, any sensor may be included, such as a temperature sensor, a wind speed sensor, an illuminance sensor, a human sensor, an electricity meter, an acceleration sensor, a distortion sensor, a monitoring camera and the like, and it is selected in accordance with implementations. The sensor interface 43 is also connected to the EEPROM 14. The EEPROM 14 appropriately stores a variety of sensor information or sensor control information. A DI/DO terminal 13 is connected to the DI/DO interface 42. The DI/DO terminal 13 operates as a data input terminal and a data output terminal.

Information detected by the sensor and data measured by the sensor is output from the sensor interface 43 to the CPU interface 24 via the FPGA interface 41. The CPU interface 24 outputs to the frame processing unit 26 input data and the like. The CPU 40 controls a sensor device designated by sensor control information on the basis of the sensor control information that was received via the FPGA interface 41.

### First Embodiment

Hereafter, explanations are given for a first embodiment by way of separately explaining a method for deciding a wait number, a method for deciding a core relay node 50 of a relay destination, and a transmission/reception of a frame after a relay destination is decided.

[A Method for Deciding a Wait Number and a Core Relay Node of a Relay Destination]

FIG. 6 illustrates an example of a network and an example of deciding a wait number. In the network illustrated in FIG. 6, an ad hoc network is connected to a server 1 though three core relay nodes 50 consisting of core relay nodes 50a to 50c. In the following explanations, “a sensor node 10 of ID=X” (here, X is any integer) may be described as “a node NX” for a brief representation. For example, “a sensor node 10 of ID=1” is described as “a node N1”. Further, in an ad hoc network of FIG. 6, sensor relay nodes 10 consisting of nodes N1 to N21 are included. FIG. 6 is an example of a network and the number of sensor relay nodes 10 or that of core relay nodes 50 may be changed in accordance with implementations.

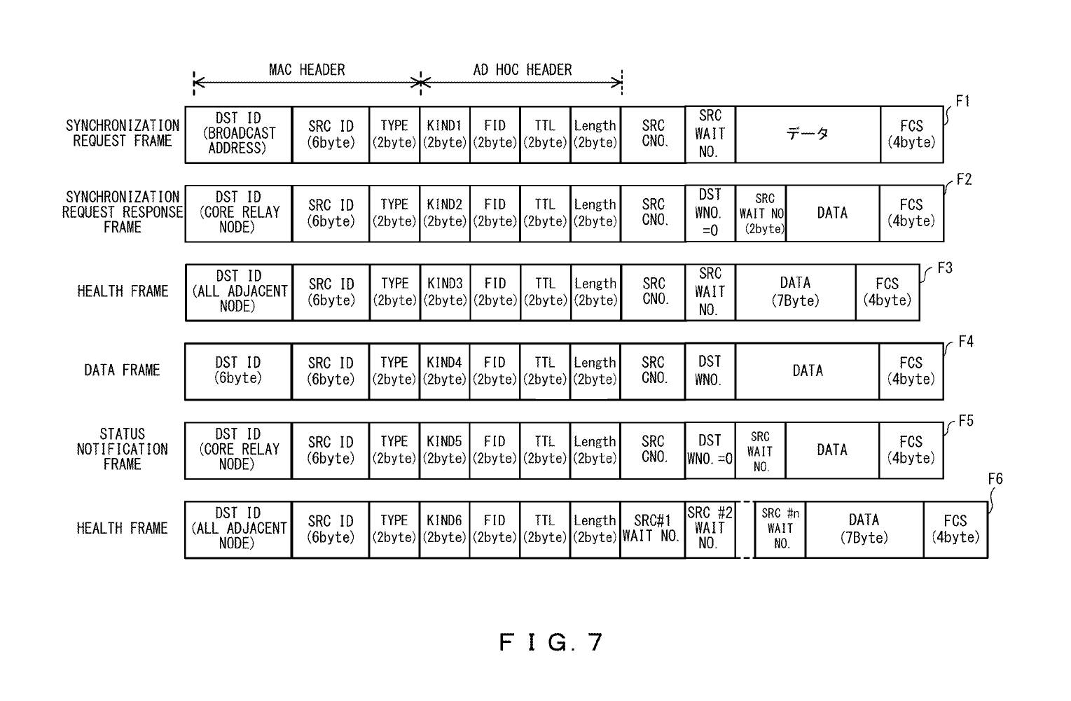

FIG. 7 illustrates an example of a format of a frame which is transmitted and received through a network of FIG. 6. In FIG. 7, examples area given of a format of a synchronization request frame, a synchronization request response frame, a health frame, a status notification frame, and a data frame. Although detailed explanations for information included in individual frames and processing performed on the basis of the frame will be given later, every type of a frame includes a field which stores information on a wait number and further includes a MAC (Media Access Control) header, an ad hoc header, a data field, and a Frame Check Sequence (FCS).

The MAC header includes a DST ID (DeSTination ID) field, an SRC ID (Source ID) field, and a TYPE field. In the DST ID field, a 6-byte MAC address assigned to an address of a frame is set. In the SRC ID field, a 6-byte MAC address assigned to a device of a transmission source is set. In the TYPE field, a 2-byte high-order protocol identification number is set, and a value 0x8847 is set, for example. Meanwhile, “0x” indicates that the subsequent value is given in hexadecimal.

The ad-hoc header has a KIND field, an FID field, a TTL field, and a Length field. In the KIND field, 2-byte data representing the kind of the ad-hoc frame is set. In the FID field, a 2-byte frame identification as the sequence number is set for example. In the TTL (Time To Live) field, 2-byte data representing the upper limit of the time for which the ad-hoc frame is able to exist in the ad-hoc network is set. In the Length field, a 2-byte value representing the data length of the data in the frame is set. The FCS is a redundant code for error detection and correction in the frame.

Hereafter, explanations are given for an example of a method for deciding a wait number and an example of a method for selecting a core relay node 50 that is designated as a relay destination when transmitting a frame to a server 1, taking a network illustrated in FIG. 6 as an example. In the following explanations, it is presupposed that a core relay number is assigned to each of core relay nodes 50a to 50c and that an individual core relay node 50 stores an assigned core relay number. Here, it is presupposed that a core relay number of a core relay node 50a is “0”, that a core relay number of a core relay node 50b is “1”, and that a core relay number of a core relay node 50c is “2”. Further, a wait number that was written in each sensor relay node 10 that is included in FIG. 6 is a wait number that was obtained in a procedure explained hereafter. A numeral subsequent to “#0:” represents a wait number in which a core relay node 50a is designated as a starting point. A numeral subsequent to “#1:” represents a wait number in which a core relay node 50b is designated as a starting point, and a numeral subsequent to “#2:” represents a wait number in which a core relay node 50c is designated as a starting point.

A procedure Pr 1 is as follows. A core relay node 50a generates a synchronization request frame as illustrated in F1 of FIG. 7. In the synchronization request frame, a transmission source core relay number and a transmission source wait number are included. In the drawing, for easy viewing, a transmission source core relay number may be described as “SRC CNo”, and a transmission source wait number may be described as “SRC WNo”, respectively. Similarly, a transmission destination wait number may be described as “DST WNo”. A core relay node 50a sets a transmission source core relay number as “0”, and sets a transmission source wait number as 0x00, respectively. That a transmission source core relay number=0 and that a transmission source wait number=0 means that a number of hops in which a core relay node 50a is designated as a starting point is 0, and indicates a core relay node 50a.

Since a broadcasting transmission is performed to a synchronization request frame, a broadcast address is set in the DST ID field. The core relay node 50 records the address of the core relay node 50a in the SRC ID field of the synchronization request frame. A KIND is set to a value which indicates that the KIND is the synchronization request frame. Here, it is presupposed that KIND=1.

A procedure Pr 2 is as follows. When a core relay node 50a performs a broadcasting transmission to a synchronization request frame, a node N1 receives the synchronization request frame. Here, it is presupposed that the node N1 receives the synchronization request frame via a port P1. A receiver 21 of the node N1 checks a KIND field of the frame that was received via a port P1. When the value of a KIND field is KIND=1, the receiver 21 judges that it has received the synchronization request frame and outputs the reception frame to a wait number control unit 31a. At this time, it is presupposed that the transmitter 22 also outputs a reception port number to the wait number control unit 31a.

A wait number generation unit 32 finds await number of a node N1 by incrementing by one a transmission source wait number of the synchronization request frame that was input to the wait number control unit 31a. Further, when the wait number generation unit 32 checks that a transmission source core relay number of the synchronization request frame is 0, the wait number generation unit 32 recognizes that a starting point of the generated wait number=1 (0x01) is a core relay node 50a. The wait number generation unit 32 updates a wait number table 33 with a generated wait number when the generated wait number is smaller than await number that has been recorded in the wait number table 33. It is presupposed, for example, that in a node N1, the wait number table 33 of the transmission source core relay number=0 is as illustrated in T1 of FIG. 4. In this case, the wait number generation unit 32 compares 0xFF, a value recorded in a wait number column, with the generated wait number 0x01. Since the generated wait number is smaller here, the wait number generation unit 32 updates a wait number in the wait number table 33 of the transmission source core relay number=0 to 0x01. At this time, the wait number generation unit 32 recognizes a port that has received a frame used for deciding the wait number as a master port. For example, in the example of the node N1, since await number is decided on the basis of the synchronization request frame received from the port P1, a master port becomes a port P1. That a wait number=1 indicates that a shortest number of hops from the core relay node 50a to the sensor relay node 10 of the node N1 is 1.

Further, the wait number generation unit 32 recognizes that the wait number of a node connected via the port P1 is 0, since the reception port of the synchronization request frame is a port P1. That is to say, the wait number generation unit 32 recognizes that it is connected to a core relay node 50 via a port P1. The wait number generation unit 32 records obtained information in the wait number table 33 of the transmission source core relay number=0. Accordingly, the wait number table 33 of the transmission source core relay number=0 is changed as illustrated in T2 of FIG. 4.

In the meantime, it is presupposed that a timer in the wait number table 33 is used to check whether or not a wait number of the connection destination is effective. The wait number generation unit 32 sets a timer value as t1 each time a wait number of the connection destination connected to each port is checked and decreases the timer value as time goes on. When the timer value becomes 0, information of the wait number of the connection destination is invalidated.

A procedure Pr 3 is as follows. The wait number generation unit 32 generates a synchronization request frame to be transmitted to the adjacent sensor relay node 10. In the synchronization request frame to be generated, an address of a node N1 is set in the SRT ID field and the transmission source wait number is set as 1. Further, the transmission source core relay number is set as 0. The wait number generation unit 32 requests of the transmitter 22 that the generated synchronization request frame of the transmission source core relay number=0 be transmitted from all ports of the node N1.

A procedure Pr 4 is as follows. When the synchronization request frame generated in the procedure Pr3 is transmitted from ports P1 to P3 of the node N1, nodes N2 and N8 receive the synchronization request frame. The nodes N2 and N8 perform processing explained in the procedure Pr2, respectively, and update the wait number table 33 of the transmission source core relay number=0. Here, since a shortest number of hops from a core relay node 50a is 2 for both nodes N2 and N8, the wait number is set as 2. Suppose here that each of the nodes N2 and N8 receives the synchronization request frame via the port P1. In this case, the wait number table 33 of the transmission source core relay number=0 is updated as illustrated in T3 of FIG. 4, for both nodes N2 and N8.

A procedure Pr 5 is as follows. Although the core relay node 50a receives the synchronization request frame that was transmitted from the node N1 via the port P1 in the procedure Pr4, the core relay node 50a does not perform processing that uses the synchronization request frame.

A procedure Pr 6 is as follows. When nodes N2 and N8 complete an update of the wait number table 33, the nodes N2 and N8 transmit the synchronization request frame to the adjacent relay node 10. The operation performed here is similar to what was explained in the procedure Pr 3. Accordingly, the node N2 reports to nodes N1, N3, and N9 that the wait number of the node N2 in which the core relay node 50a is designated as a starting point is 2 and makes a request for a synchronization. In addition, the node N8 reports to nodes N1, N9, and N15 that the wait number of the node N8 in which the core relay node 50a is designated as a starting point is 2 and makes a request for a synchronization.

A procedure Pr 7 is as follows. The node N1 receives the synchronization request frame via a port P2 from a node N2. The wait number generation unit 32 of the node N1 increments the transmission source wait number of the synchronization request frame by one and compares the obtained value with the value that is recorded in the wait number table 33. At this time, the wait number generation unit 32 defines as a comparison target a wait number being recorded in the wait number table 33 that is associated with the same transmission source core relay number as the transmission source core relay number (=0) of the synchronization request frame of a processing target. Here, the wait number calculated for the node N1 becomes 3. As illustrated in T2 of FIG. 4, since 1 is registered as the wait number of the transmission source core relay number=0, the wait number generation unit 32 does not update the wait number in the wait number table 33.

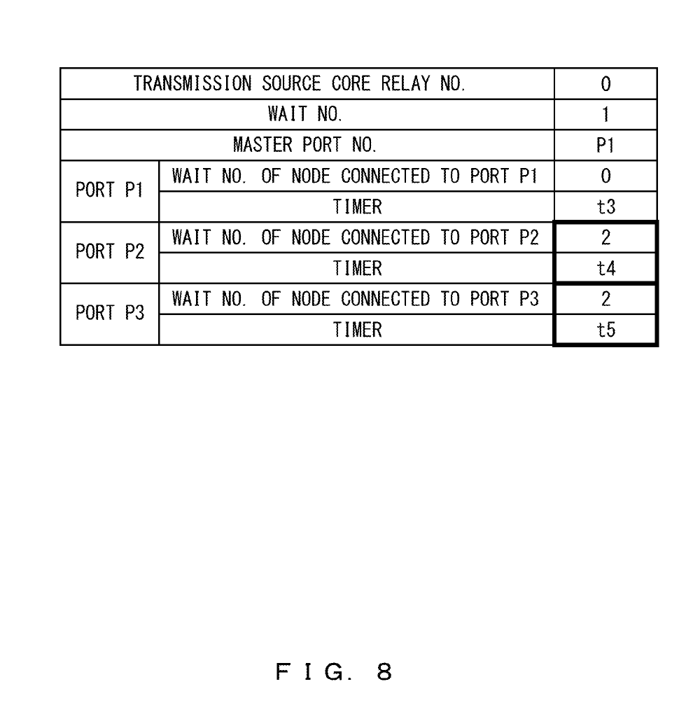

Further, the wait number generation unit 32 recognizes that the wait number of the node N2 in which the core relay node 50a is designated as a starting point is 2 on the basis of the synchronization request frame received from the node N2. Since the synchronization request frame from the node N2 is received from the port P2, information of the port P2 is updated in the node N1 as illustrated in FIG. 8.

The node N1 processes the synchronization request frame received from the node N8 via the port P3 similarly to the synchronization request frame received from the node N2. Although the wait number of the node N1 in which the core relay node 50a is designated as a starting point is not changed by the processing of the synchronization request frame received from the node N8, the node N1 recognizes that the wait number of the node N8 in which the core relay node 50a is designated as a starting point is 2. Therefore, the wait number generation unit 32 updates information of the port P3 of the wait number table 33 of the transmission source core relay number=0, as illustrated in FIG. 8.

A procedure Pr 8 is as follows. Due to a transmission/reception of a synchronization request frame of a transmission source core relay number=0 to and from the adjacent sensor relay nodes 10, a wait number designating a core relay node 50a as a starting point in all sensor relay nodes 10 that are included in the ad hoc network is obtained. The processing which is performed at an individual sensor relay node 10 is similar to procedures Pr2 to Pr7. A wait number in which a core relay node 50a is designated as a starting point is illustrated as a numeral subsequent to “#0:” in FIG. 6. As illustrated in FIG. 6, the wait number subsequent to “#0:” of each sensor relay node 10 becomes a shortest number of hops from the core relay node 50a.

A procedure Pr 9 is as follows. Similarly to the above, a core relay node 50b generates a synchronization request frame and performs a broadcasting transmission. In the synchronization request frame generated in the core relay node 50b, a transmission source core relay number=1 and a transmission source wait number=0x00 are set. That the transmission source core relay number=1 and the transmission source wait number=0 indicates that a number of hops in which a core relay node 50b is designated as a starting point is 0.

A procedure Pr 10 is as follows. A node N4, when it receives a synchronization request frame of a transmission source core relay number=1 from the core relay node 50b, updates a wait number table 33 of the transmission source core relay number=1. The procedure of the update is similar to the procedure as explained for the procedure Pr 2. Further, the node N4 transmits the synchronization request frame to the sensor relay nodes N10 (node N3 and node N5) that are adjacent to the node N4 by the procedure similar to what was explained in the procedure Pr 3.

Due to a transmission/reception of a synchronization request frame of a transmission source core relay number=1 to and from the adjacent sensor relay nodes 10, a wait number indicated in association with “#1:” in FIG. 6 is obtained, in each sensor relay node 10. The wait number described subsequent to “#1:” of each sensor relay node 10 becomes a shortest number of hops from the core relay node 50b.

A procedure Pr 11 is as follows. Similarly to the above, a core relay node 50c generates a synchronization request frame and performs a broadcasting transmission. In the synchronization request frame generated in the core relay node 50c, a transmission source core relay number=2 and a transmission source wait number=0x00 are set. That the transmission source core relay number=2 and the transmission source wait number=0 indicates that a number of hops in which a core relay node 50c is designated as a starting point is 0.

A procedure Pr 12 is as follows. A node N7, when it receives a synchronization request frame of a transmission source core relay number=2 from the core relay node 50c, updates a wait number table 33 of the transmission source core relay number=2. The procedure of the update is similar to the procedure as explained for the procedure Pr 2. Further, the node N7 transmits the synchronization request frame to the sensor relay nodes N10 (node N6 and node N14) that are adjacent to the node N7 using a procedure that is similar to that explained in the procedure Pr 3.

Due to a transmission/reception of a synchronization request frame of a transmission source core relay number=2 to and from adjacent sensor relay nodes 10, a wait number indicated in association with “#2:” in FIG. 6 is obtained, in each sensor relay node 10. A wait number described subsequent to “#2:” in each sensor relay node 10 becomes a shortest number of hops from the core relay node 50c.

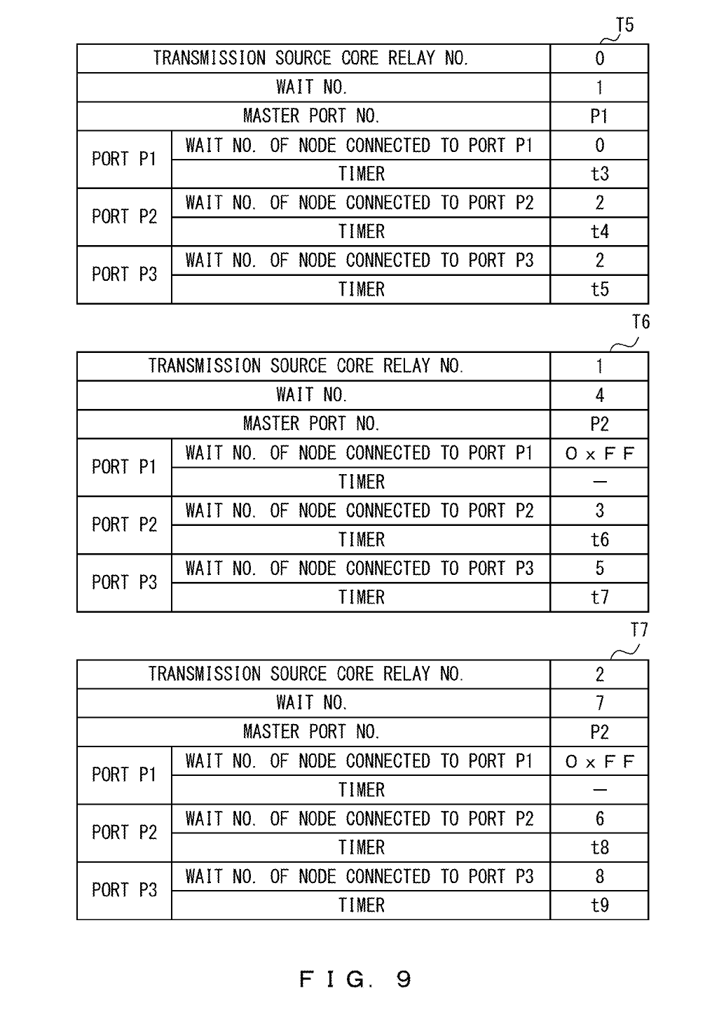

A procedure Pr 13 is as follows. A wait number table 33 maintained by a node N1 when procedures Pr1 to Pr12 are completed is illustrated in FIG. 9. T5 of FIG. 9 is the wait number table 33 in which a core relay node 50a is designated as a starting point. Further, T6 of FIG. 9 is the wait number table 33 in which a core relay node 50b is designated as a starting point, and T7 of FIG. 9 is the wait number table 33 in which a core relay node 50c is designated as a starting point.

A procedure Pr 14 is as follows. When a wait number is decided for each of the core relay nodes 50a to 50c, a selection unit 35 compares the wait number for each core relay node 50 and decides a core relay node 50 having a smallest wait number. The decided core relay node 50 is used as a relay destination of a frame to be transmitted from the sensor relay node 10 to a server 1. The selection unit 35 records the decided relay node 50 in a node management table 29 (FIG. 5). For example, in the node N1, the wait number is as follows.

The wait number in which a core relay node 50a is designated as a starting point: 1

The wait number in which a core relay node 50b is designated as a starting point: 4

The wait number in which a core relay node 50c is designated as a starting point: 7

Then, the selection unit 35 of the node N1 decides to set the core relay node 50a as a relay destination and records it in a node management table 29. Similarly, the core relay node 50 is selected in other sensor relay nodes 10.

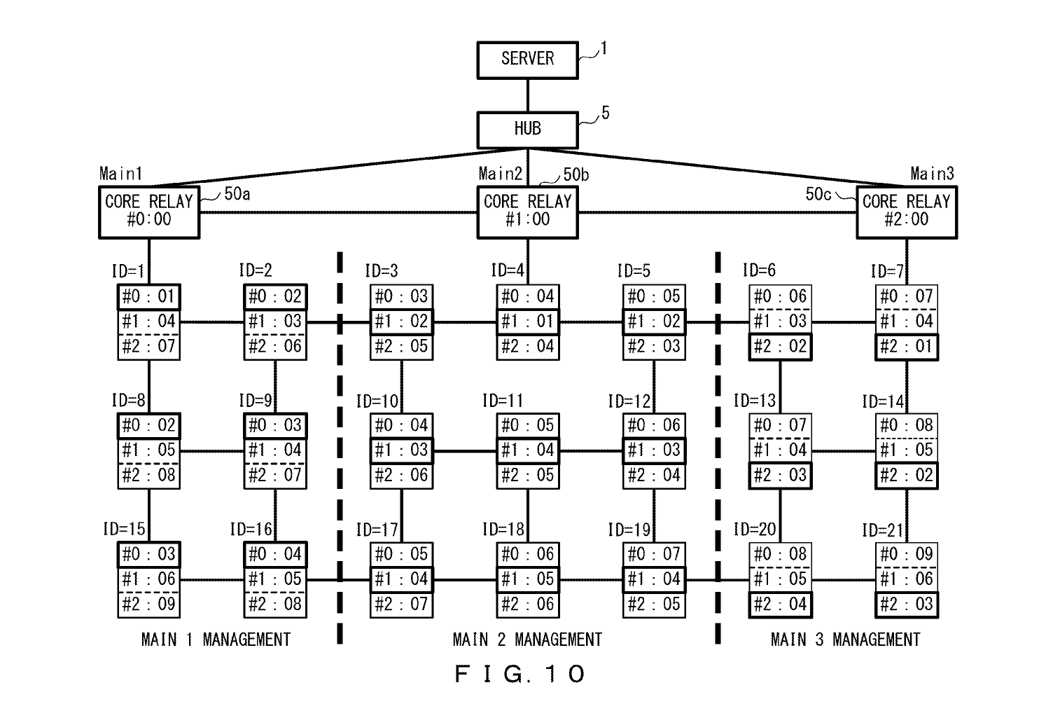

An example of a relay destination decided at each sensor relay node 10 is illustrated in FIG. 10. Here, the wait number surrounded by boldface is a smallest value of a wait number for each sensor relay node 10, and the core relay node 50 which has become the starting point of the wait number surrounded by boldface is used as a relay destination to a server 1. In the example of FIG. 10, nodes N1, N2, N8, N9, N15, and N16 designate a core relay node 50a as a relay destination. Further, nodes N3, N4, N5, N10, N11, N12, N17, N18, and N19 designate a core relay node 50b as a relay destination. Nodes N6, N7, N13, N14, N20, and N21 designate a core relay node 50c as a relay destination. Hereafter, the sensor relay node 10 that designates the core relay node 50 as a relay destination may be described as a sensor relay node 10 of “a management target” for the core relay node 50.

A procedure Pr 15 is as follows. A sensor relay node 10 transmits a synchronization request response frame to a core relay node 50 designated as a relay destination. The synchronization request response frame is used to report to the core relay node 50 designated as the address that it is designated as a relay destination to a server 1 by the sensor relay node 10 of a transmission source. An example of a format of the synchronization request response frame is illustrated in F2 of FIG. 7. The address of the synchronization request response frame is set as the address of the core relay node 50 designated as the relay destination, and the transmission destination wait number is set as 0. The transmission source wait number is recorded as well. In addition, in the synchronization request response frame, it is presupposed that a value of a KIND field is KIND 2. Further, in the synchronization request response frame, a transmission source core relay number assigned to the core relay node 50 that is designated as a relay destination to the server 1 is also recorded. The selection unit 35 generates the synchronization request response frame and transmits the generated synchronization request response frame to the core relay node 50 that is designated as the address. For example, a node N1 transmits a synchronization request response frame to a core relay node 50a.

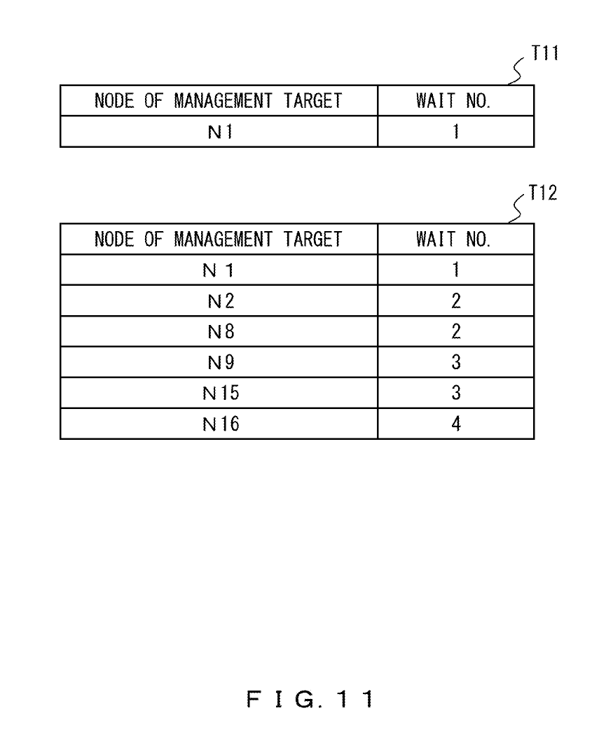

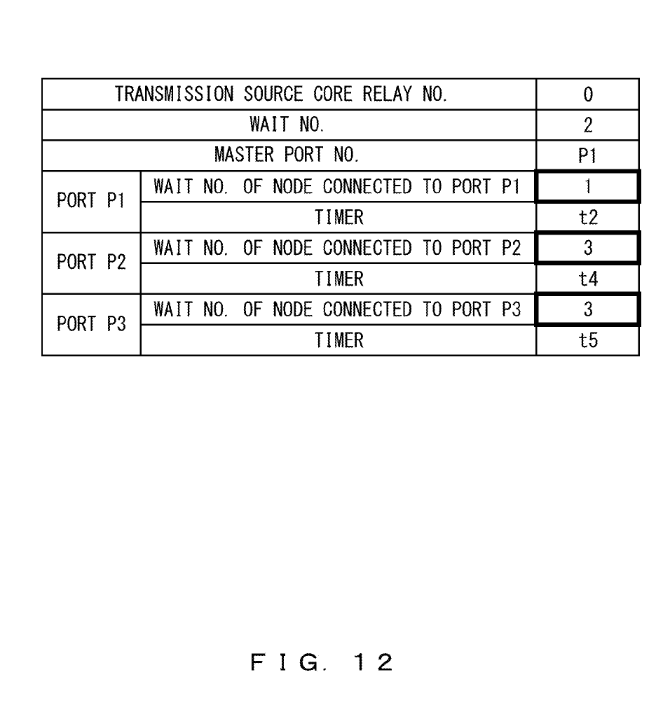

A procedure Pr 16 is as follows. When a core relay node 50a receives a synchronization request response frame from a node N1, it associates a transmission source address of the synchronization request response frame with a wait number of the sensor relay node 10 of the transmission source to store them. The core relay node 50a may store, in a table as illustrated in T11 of FIG. 11 for example, an address of a node N1 in association with the wait number of the node N1. In T11 of FIG. 11, the address of a node of a management target is indicated by using a number assigned to the sensor relay node 10 such as “N1” or the like, for ease of viewing the table.

A procedure Pr 17 is as follows. A sensor relay node 10 other than a node N1 similarly transmits a synchronization request response frame to a core relay node 50 of a relay destination. Here, the synchronization request response frame transmitted from the sensor relay node 10 that is not adjacent to the core relay node 50 is transmitted to the core relay node 50 via another sensor relay node 10 in the ad hoc network. At this time, the sensor relay node 10 of a transmission source transmits a synchronization request response frame to the sensor relay node 10 having a small wait number in which a core relay node 50 of a transmission destination is designated as a starting point. A selection unit 35 may appropriately refer to the wait number table 33 when deciding a port that outputs the synchronization request response frame.

FIG. 12 illustrates an example of the wait number table 33 of the transmission source core relay number=0 provided by the node N2 when a wait number is assigned as illustrated in FIG. 6. When the node N2 transmits the synchronization request response frame to the core relay node 50a, it checks the wait number table 33 which is illustrated in FIG. 12. A selection unit 35 compares wait numbers of a connection destination of ports P1 to P3 and recognizes that the wait number of the sensor relay node 10 connected to the port P1 is smaller than the wait number of the node N2. Then, the selection unit 35 of the node N2 requests of the transmitter 22 that the synchronization request response frame be output from the port P1. The node N2 transmits the synchronization request response frame from the port P1 to the core relay node 50a.

A procedure Pr 18 is as follows. Anode N1 receives from a node N2 a synchronization request response frame. Then, the routing unit 38 of the node N1 checks whether or not a transmission source core relay number of the synchronization request response frame matches up with a core relay number of the core relay node 50 which the node N1 designates as a relay destination. Here, since both are matched, the node N1 decides to transfer the received synchronization request response frame. The routing unit 38 checks the wait number and decides a port that outputs the received frame. The routing unit 38 refers to a wait number table 33 illustrated in T5 of FIG. 9 and outputs a reception frame from a port P1. In addition, the routing unit 38 associates the address of the output frame with the port of the output destination and records them in the PS table 28. Accordingly, in the node N1, the output port to the core relay node 50a is recorded in the PS table 28.

A procedure Pr 19 is as follows. Since the core relay node 50a is connected to a port P1 of the node N1, by the processing of the procedure Pr 18, the core relay node 50a receives the synchronization request response frame in which the node N2 is the transmission source. The core relay node 50a stores information on the node N2 similarly to the procedure Pr16.

The procedure Pr20 is as follows. The synchronization request response frame is also transmitted from the sensor relay node 10 that is other than the nodes N1 and N2. Here, the operation performed in the sensor relay node 10 of the transmission source of the synchronization request response frame is similar to the procedure Pr17. Further, the operation of the sensor relay node 10 that relays the synchronization request response frame is similar to the procedure Pr18. With the synchronization request response frame, the core relay nodes 50a to 50c recognize the node of a target for which each of the nodes relays a communication with the server 1. For example, when a relay destination is selected as illustrated in FIG. 10, the core relay node 50a stores a table illustrated in T12 of FIG. 11. An individual core relay node 50 informs the server 1 of the sensor relay node 10 of a management target. The server 1 decides a core relay node 50 that transmits a frame on the basis of information reported from the core relay node 50, when transmitting a frame to the sensor relay node 10.

Methods mentioned so far above are examples of methods for deciding a wait number or a core relay node 50 of a relay destination and these methods may be changed in accordance with implementations. For example, in the above-mentioned explanations, the wait number in which a core relay node 50b is designated as a starting point is decided after the wait number has been decided in which a core relay node 50a is designated as a starting point, and then a wait number in which a core relay node 50c is designated as a starting point is decided. However, the wait number in which a core relay node 50b is designated as a starting point or the wait number in which a core relay node 50c is designated as a starting point may be decided before the wait number in which a core relay node 50a is designated as a starting point is decided. Further, the core relay node 50 which is designated as a starting point in deciding the wait number is selected by arbitrary methods.

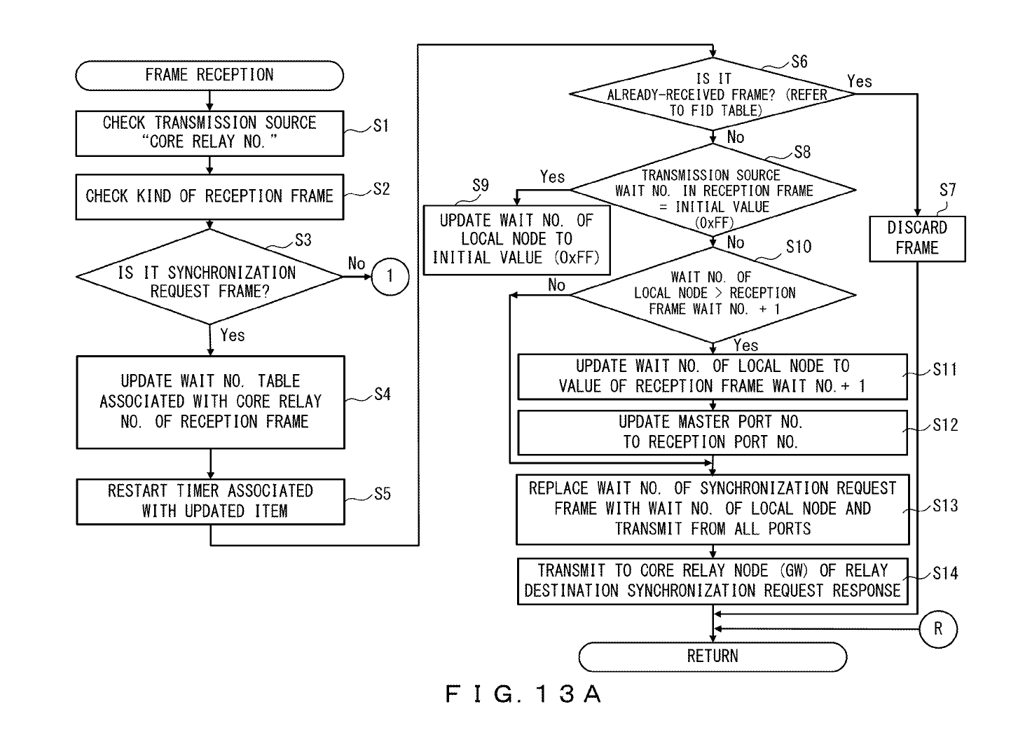

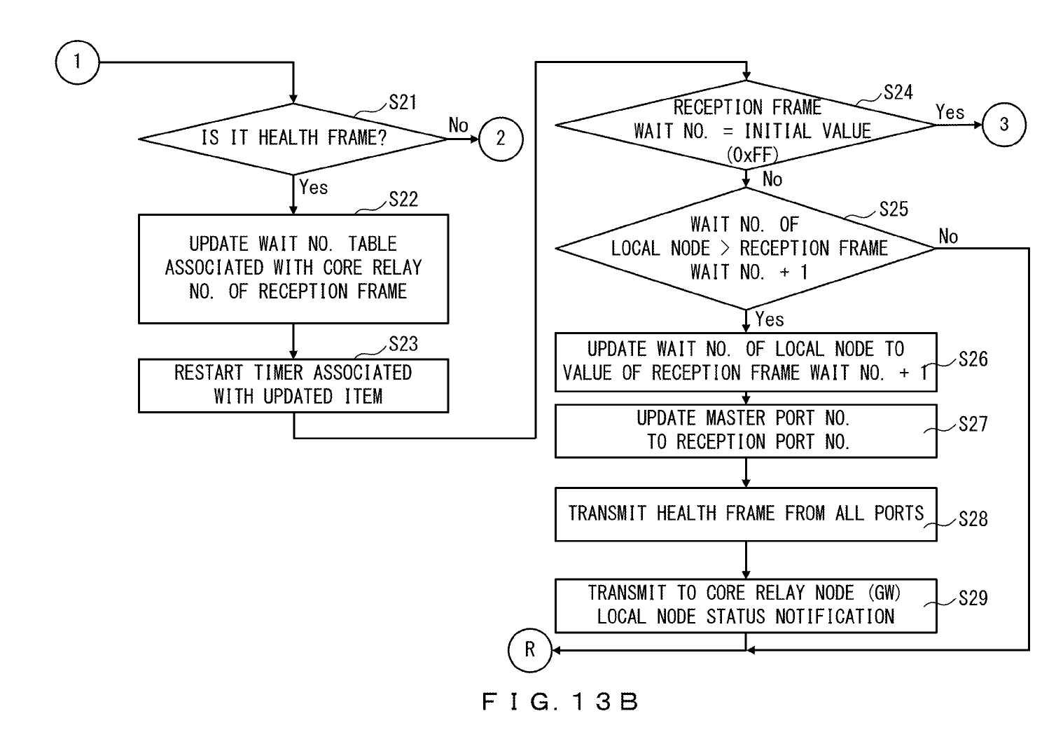

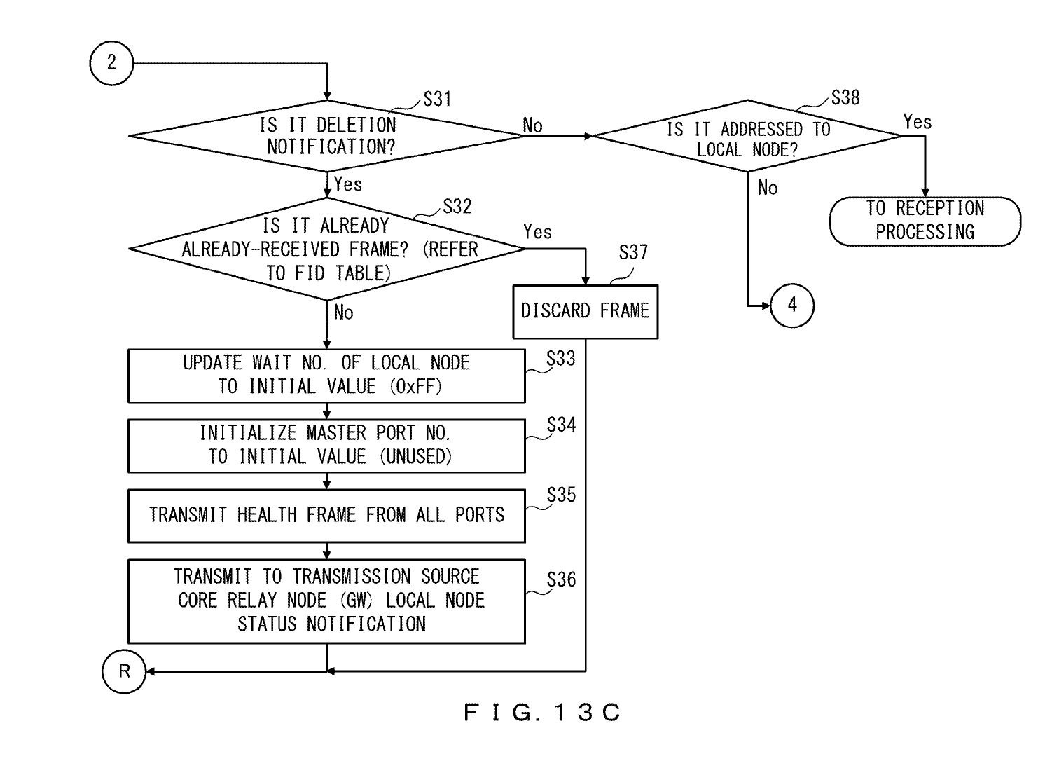

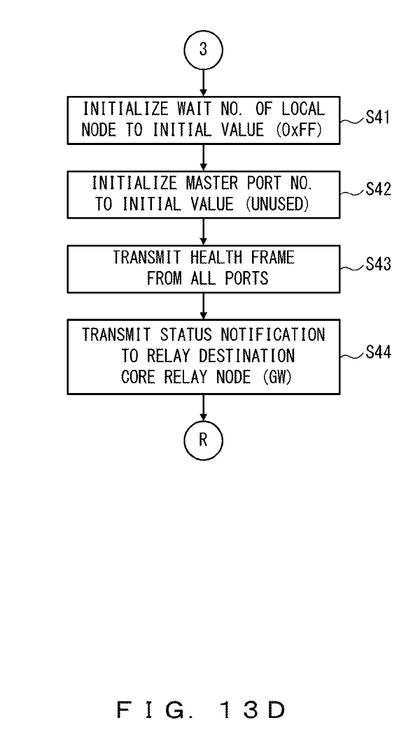

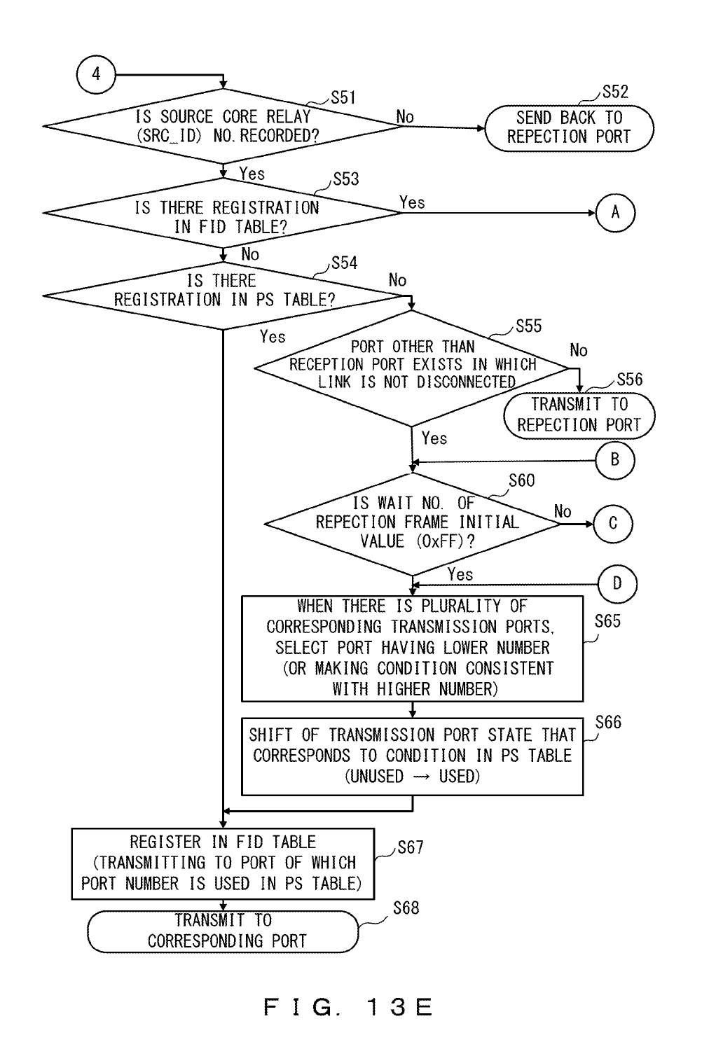

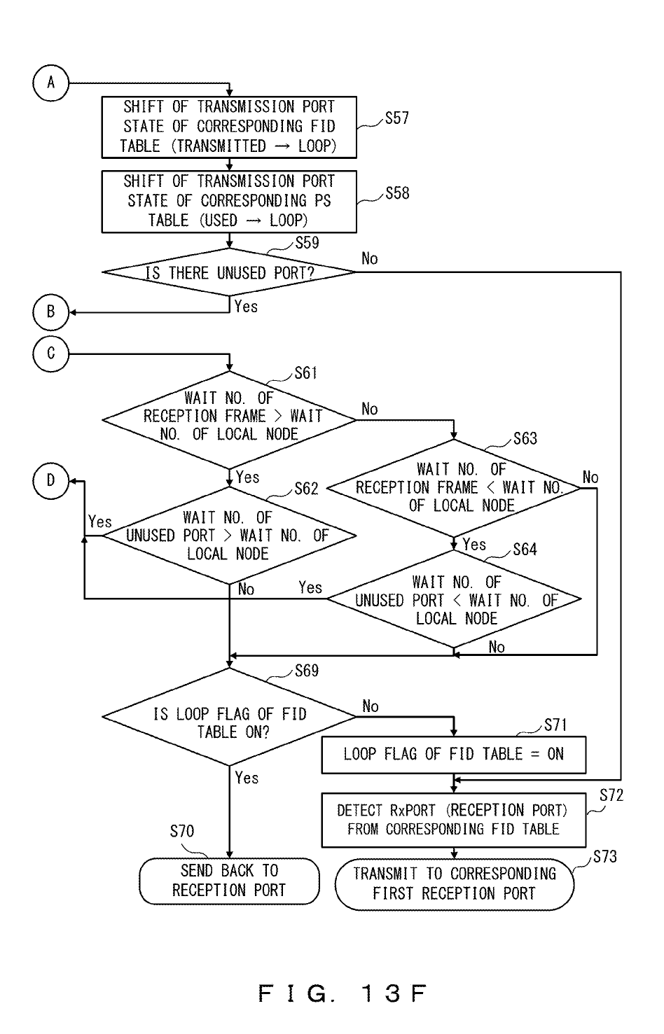

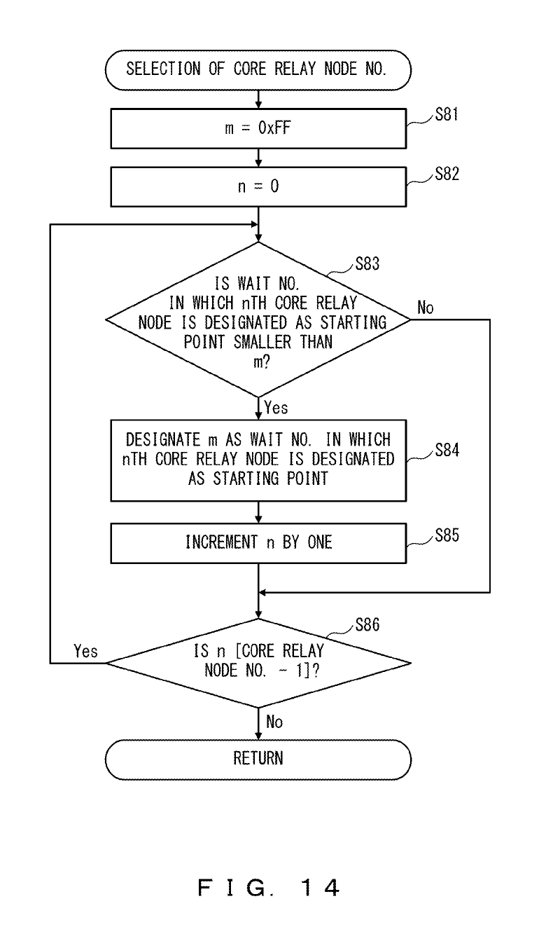

FIG. 13A to FIG. 13F illustrate a flowchart which explain the operation of the sensor relay node 10 when it receives a frame. FIG. 13A explains the procedure performed in the sensor relay node 10 in deciding the core relay node 50 of the relay destination. The sensor relay node 10, when it receives the frame, checks a transmission source core relay number and a value of a KIND field in the frame, and judges whether or not the reception frame is a synchronization request frame (steps S1 to S3). Explanations will be given later in reference to FIG. 13B to FIG. 13F for a case when the reception frame is not a synchronization request frame.

When the wait number generation unit 32 receives the synchronization request frame, it updates information of a port which received a frame for the wait number table 33 in which the core relay node 50 associated with the transmission source core relay number of the synchronization request frame is designated as a starting point. That is to say, the wait number generation unit 32 sets the wait number of the connection destination of a port that received the synchronization request frame as the transmission source wait number in the synchronization request frame (step S4). In addition, it restarts a timer that is associated with the wait number of the connection destination that was updated in step S4 (step S5). Further, the wait number generation unit 32 checks whether or not it received a frame that is identical to the already received frame in reference to an FID table 27 (step S6). That is to say, the wait number generation unit 32 judges whether or not a combination of a value of an SRC ID field of the reception frame and a value of an FID field is registered in the FID table 27. When the combination of a value of an SRC ID field and a value of an FID field is registered in the FID table 27, the wait number generation unit 32 judges that it received the already received frame (Yes in step S6). In this case, the wait number generation unit 32 deletes the reception frame (step S7).

When the combination of a value of an SRC ID field and a value of an FID field is not registered in the FID table 27, the wait number generation unit 32 performs processing of the wait number of the node (local node) that received a frame (No in step S6). In the processing of steps S8 to S13, the processing of the wait number in which the core relay node 50 associated with the transmission source core relay number of the reception frame is designated as a starting point is performed.

The wait number generation unit 32 checks whether or not the transmission source wait number in the received frame is an initial value (0xFF) (step S8). When the transmission source wait number in the received frame is an initial value, the wait number generation unit 32 updates the wait number of the node that received the frame to an initial value (Yes in step S8, step S9). On the other hand, when the transmission source wait number in the reception frame is not an initial value, the wait number generation unit 32 checks whether or not the wait number of the node which received the frame is larger than a value in which the wait number in the reception frame is incremented by 1 (step S10). When the wait number of the node which received the frame is larger than a value in which the wait number in the reception frame is incremented by 1, this means that a shortest number of hops is updated by the reception frame (Yes in step S10). Then, the wait number generation unit 32 updates the wait number of the local node to a value in which the wait number of the reception frame is incremented by 1, and further, updates the master port No. to a reception port No. of the frame (steps S11, S12). On the other hand, when the wait number of the node which received the frame is not larger than a value in which the wait number in the reception frame is incremented by 1, a shortest number of hops is not updated even when the reception frame is used (No in step S10). Then, when it is judged as No in step S10, the wait number of the local node is not updated.

After that, the wait number generation unit 32 replaces the wait number of the synchronization request frame with the wait number of the local node, changes the SRC ID to the address of the local node, and then transmits it from all ports (step S13). Further, when the wait number generation unit 32 decides a core relay node 50 of a relay destination to a server 1 by using a wait number, it transmits a synchronization request response frame to the decided core relay node 50 (step S14).

FIG. 14 is a flowchart which explains an example of an operation of a selection unit 35 in selecting a core relay node 50 of a relay destination. The selection unit 35 sets 0xFF in a variable m which indicates a smallest wait number when the wait number in which all core relay nodes 50 in the network are designated as a starting point is decided (step S81). Further, the selection unit 35 sets a variable n for specifying the core relay number that was assigned to the core relay node 50 which is selected as a relay destination as 0 (step S82). Next, the selection unit 35 determines whether or not a wait number in which the core relay node 50 of the core relay number=n is designated as a starting point is smaller than m (step S83). When a wait number in which the core relay node 50 of the core relay number=n is designated as a starting point is smaller than m, the selection unit 35 sets the wait number in which the core relay node 50 of the core relay number=n is designated as a starting point as a value of m (step S84). Next, the selection unit 35 increments a value of n by 1 (step S85). On the other hand, when a wait number in which the core relay node 50 of the core relay number=n is designated as a starting point is not smaller than m (No in step S83), no processing of steps S84 and S85 is performed. After that, the selection unit 35 compares a value of n with a number obtained by subtracting 1 from the total number of the core relay nodes 50, and repeats the processing of steps S83 to S86 until both values are matched. When both values are matched, the selection unit 35 selects a core relay node 50 in which the core relay number is identical to a value set in n as a relay destination.

[A Transmission and Reception of a Frame after a Relay Destination has been Decided]

When a relay destination has been decided, the sensor relay node 10 transmits a health frame to the adjacent sensor relay node 10 on a regular basis. The health frame is used to report to the adjacent node that the sensor relay node 10 of the transmission source is operating normally. Further, when a wait number changes, the changed wait number is reported by the health frame.

An example of the health frame is illustrated in F3 of FIG. 7. In the health frame, an address is set in a DST ID field, the address indicating all sensor relay nodes 10 that are adjacent to the sensor relay node 10 of the transmission source. In addition, the transmission source core relay number and the wait number designating the core relay node 50 that corresponds to the transmission source core relay number as a starting point are also reported by the health frame. In F3 of FIG. 7, since a set of the transmission source core relay number and the wait number is included, the sensor relay node 10 may obtain the wait number from each of the core relay nodes 50 by using a plurality of health frames. Here, the transmission source core relay number in the health frame may be set as the core relay node 50 that was selected on the basis of arbitrary criteria by the sensor relay node 10 of the transmission source. For example, the sensor relay node 10 may report the transmission source core relay number which indicates the core relay node 50 decided as a relay destination and the wait number designating the core relay node 50 of the relay destination as a starting point with the health frame. Further, when the health frame is used, it is presupposed that a value of a KIND field is KIND 3.

Explanations are given for an example of an operation of the sensor relay node 10, in reference to FIG. 13A and FIG. 13B, when receiving the health frame. When the reception frame is not the synchronization request frame, it is determined to be No in step S3 of FIG. 13A, and it is determined whether or not the reception frame is a health frame in step S21 of FIG. 13B (step S21). Here, it is presupposed that the reception frame is a health frame (Yes in step S21). Then, processing of steps S22 and S23 is performed by the wait number generation unit 32. This processing is similar to the processing of steps S4 and S5 that were explained in reference to FIG. 13A.

The wait number generation unit 32 checks whether or not a transmission source wait number in the received health frame is an initial value (0xFF) (step S24). Here, explanations are given for a case when the wait number is not the initial value (No in step S24), and explanations will be given later for a case when the wait number is the initial value. When the wait number is not the initial value, the wait number generation unit 32 performs processing of the wait number of the node (local node) that received the frame. In steps S25 to S29, processing of the wait number designating the core relay node 50 associated with the transmission source core relay number of the reception frame as a starting point is performed.

The wait number generation unit 32 checks whether or not the wait number of the local node is larger than a value in which the wait number of the reception frame is incremented by 1 (step S25). The wait number of the node which received the frame goes back to step S1, when the wait number of the node that received the frame is not larger than a value in which the wait number of the reception frame is incremented by 1 (No in step S25).

When the wait number of the node which received the frame is larger than a value in which the wait number of the reception frame is incremented by 1, this indicates that a shorter path has been found after the local node decided the relay destination. Accordingly, the wait number is changed by the health frame (steps S26 and S27). Steps S26 and S27 are similar to steps S11 and S12 that were explained in reference to FIG. 13A. Then, the wait number generation unit 32 generates a health frame and outputs it from all ports (step S28). Further, when the wait number of the local node is updated, the wait number generation unit 32 decides the core relay node 50 of the relay destination to the server by using the wait number. When the core relay node 50 of the relay destination is changed, the wait number generation unit 32 transmits to the core relay node 50 a status notification frame (step S29).

Next, explanations are given for a transmission/reception of the data frame that is performed between the sensor relay node 10 and the server 1. An example of a data frame is illustrated in F4 of FIG. 7. In the data frame, an address which indicates the server 1 of the address or an address which indicates the sensor relay node 10 is set in the DST ID field. In addition, the transmission source core relay number and the wait number of the transmission destination designating the core relay node 50 associated with the transmission source core relay number are also included in the data frame. When the data frame is transmitted from the sensor relay node 10 to the server 1, the wait number of the core relay node 50 is designated as a relay destination, that is, 0 is set as the transmission destination wait number. On the other hand, when the data frame is transmitted from the server 1 to a specific sensor relay node 10, the transmission destination wait number is set by the core relay node 50. The core relay node 50 searches the table of the wait number illustrated in FIG. 11 with an address of the data frame received from the server 1 as a key and obtains the wait number of the sensor relay node 10 that is a management target. The core relay node 50 records the obtained wait number in the data frame and transfers the processed data frame to the sensor relay node 10.

When the data frame is transmitted to the server 1, the sensor relay node 10 of the transmission source transmits the data frame from a port connected to the node to which the wait number that is smaller than the wait number of the local node is assigned. Similarly, the sensor relay node 10 which relays the data frame transmits the data frame from a port connected to the node to which the wait number that is smaller than the wait number of the local node is assigned.

On the other hand, when the data frame is transmitted from the server 1 to a specific sensor relay node 10, the core relay node 50 transmits a data frame to the adjacent sensor relay node 10. Further, the sensor relay node 10 that relays the data frame transmits the data frame from a port connected to the node to which the wait number that is larger than the wait number of the local node is assigned.

Further, in both cases in which the data frame is transmitted to the server 1 and in which the data frame is transmitted to a specific sensor relay node 10, the wait number generation unit 32 checks a generation of a loop by using an FID table 27.

Explanations are given, in reference to FIG. 13A, FIG. 13B, FIG. 13C, FIG. 13E, and FIG. 13F, for an example of processing when the data frame is transferred. Processing of steps S1 to S3 of FIG. 13A is performed in the sensor relay node 10 which received the data frame as well. When a received frame is a data frame, it is determined as No in step S3, and a judgment of step S21 of FIG. 13B is made. When a received frame is not a health frame, it is determined as No in step S21, and in step S31 of FIG. 13C, it is judged whether or not a received frame is a deletion notification. When a received frame is a deletion notification, a sensor relay node 10 refers to an FID table and determines whether or not it is an already received frame (Yes in step S31, step S32). When it is a firstly received frame, the sensor relay node 10 updates a wait number of a local node to an initial value (No in step S32, step S33). The sensor relay node 10 further updates a master port number to an initial value (step S34). The sensor relay node 10 transmits a health frame from all ports (step S35). In addition, the sensor relay node 10 transmits a status notification frame to a core relay node 50 (step S36). On the other hand, the sensor relay node 10, when determining to have received an already received frame in step S32, deletes the received frame (Yes in step S32, step S37). A deletion notification is a kind of a control frame and will be mentioned later. When the data frame has been received, since it is determined as No in step S31, in step S38, it is determined whether or not an address of the data frame is a local node. When the address of the data frame is a local node, data in the data frame is output to a CPU 40 via a CPU interface 24 and processing is performed (Yes in step S38). On the other hand, when the address of the data frame is not a local node (No in step S38), routing processing illustrated in FIG. 13E and FIG. 13F is performed.

The routing unit 38 checks whether or not the transmission source core relay number is recorded in the data frame (step S51). When the transmission source core relay number is not included in the data frame, the routing unit 38 sends back the data frame to the reception port (step S52). Next, the routing unit 38 obtains an SRC ID and an FID from the data frame, and searches an FID table 27 with the obtained SRC ID and the FID as keys (step S53). When there is no entry that hits in the FID table 27, the routing unit 38 searches a PS table 28 with the destination address of the data frame as a key (No in step S53, step S54). When there are entries that hit in the PS table 28, the routing unit 38 decides to transmit the data frame from the port that is recorded as a port by which the data frame may be transmitted to the obtained entries (Yes in step S54). Then, the routing unit 38 generates in the FID table 27 the entry that includes the SRC ID and the FID of the data frame (step S67). Further, the routing unit 38 records, in the generated entry, a port number for transmitting the data frame as “a port under transmission”. Then, the routing unit 38 reports a transmission port to a transmitter 22 and makes the data frame be transmitted from the transmitter 22 (step S68).

When there is no entry that hits in the PS table 28, the routing unit 38 sends a query to the transmitter 22 of whether or not a wired ad hoc network port 11 exists in which a link other than a port that received a data frame is not disconnected (No in step S54). When there is no port in which a link is not disconnected, the routing unit 38 judges that the routing of the data frame is not performed and outputs the data frame from the reception port (No in step S55, step S56). On the other hand, when there are some ports in which a link is not disconnected, the routing unit 38 determines whether or not the transmission destination wait number that is set in the reception frame is an initial value (0xFF) (Yes in step S55, step S60).

When a transmission destination wait number of the data frame is an initial value, the routing unit 38 does not perform routing processing that uses the wait number (Yes in step S60). When a plurality of ports exist that were reported from the transmitter 22, the routing unit 38 selects a port having a lower number (or makes conditions consistent with a higher number and the like) (step S65). Next, the routing unit 38 generates in the PS table 28 an entry that is associated with the destination address of the reception frame and sets a port that was selected in step S65 as “a port under transmission” (step S66).

On the other hand, in step S53, when an entry which hits the FID table 27 has been found, the routing unit 38 judges that the frame that was once received and was transmitted to another sensor relay node 10 has been returned (Yes in step S53). In this case, the routing unit 38 changes a state of the port which is set as “a port under transmission” in the FID table 27 into “a loop port” (step S57). Here, that a certain port is set as “a loop port” means that a frame is not transmittable to the destination address from this port. Next, the routing unit 38 searches a PS table 28 by setting a destination address of a data frame as a key, and sets “a loop state” to the port that is set as “a port under transmission” in the obtained entry (step S58). Next, the routing unit 38 determines whether or not a port exists which is set in an “unused state” by searching for corresponding entries in the PS table 28 (step S59).

When there is no unused port (No in step S59), the routing unit 38 extracts an entry that has been associated with the transmission source address of the reception frame and obtains an RxPort (reception port) of the entry (step S72). Then, the routing unit 38 returns the reception frame to the extracted first port and transmits it (step S73).

On the other hand, when there is an unused port (Yes in step S59), the routing unit 38 performs processing of step S60 in order to perform transmission processing by selecting the unused port. When the wait number of the reception frame is an initial value (Yes in step S60), processing of steps S65 to S68 is performed. When the wait number of the reception frame is not an initial value (No in step S60), the routing unit 38 determines whether or not a transmission destination wait number in the reception frame is larger than the wait number of the local node (step S61). When a transmission destination wait number in the reception frame is larger than the wait number of the local node, the routing unit 38 recognizes that it relays a frame to the sensor relay node 10 that is more remote from a server 1 than the local node. Then, the routing unit 38 checks whether or not the frame may be transmitted from a port connected to a node to which a wait number that is larger than the wait number of the local node is assigned (step S62). When the frame may be transmitted from a port connected to anode to which a wait number that is larger than the wait number of the local node is assigned (Yes in step S62), processing from steps S65 to S68 is performed. On the other hand, when a frame is not transmitted to a node to which a wait number which is larger than the wait number of the local node is assigned (No in step S62), the routing unit 28 determines whether or not a Loop flag of the FID table 27 is “ON” (step S69). When the Loop flag is “ON”, it is already recorded that the sensor relay node 10 which is set as the address of the data frame does not exist in a connection destination of the local node (Yes in step S69). Then, the routing unit 38 sends back the data frame to a port that received the data frame (step S70).

On the other hand, when the Loop flag is “OFF”, it is not recorded in the FID table 27 that the sensor relay node 10 which is set as the address of the data frame does not exist in a connection destination of the local node (No in step S69). Then, the routing unit 38 sets the Loop flag of the FID table 27 as “ON” (step S71). After that, the routing unit 38 searches the FID table 27 for an entry setting the transmission source address (SRC ID) of the reception frame as a key, and specifies the RxPort (reception port) of the hit entry (step S72). The routing unit 38 sends back the reception frame to the extracted first reception port and transmits it (step S73).

Next, when a determination of step S61 is No, the routing unit 38 determines whether or not the transmission destination wait number in the reception frame is smaller than the wait number of the local node (step S63). When the transmission destination wait number in the reception frame is smaller than the wait number of the local node, the routing unit 38 recognizes that it relays a frame to the sensor relay node 10 that is more approximate to the server 1 than the local node (Yes in step S63). When the transmission destination wait number in the reception frame is smaller than the wait number of the local node, the routing unit 38 checks whether or not it is possible to transmit a frame from a port connected to the node to which a wait number that is smaller than the wait number of the local node is assigned (step S64). When it is possible to transmit a frame from a port connected to the node to which a wait number that is smaller than the wait number of the local node is assigned (Yes in step S64), the processing of steps S65 to S68 is performed.

On the other hand, when it is not possible to transmit a frame from a port connected to the node to which a wait number that is smaller than the wait number of the local node is assigned (No in step S64), processing for which explanations have been given in reference to steps S69 to S73 is performed. In addition, in step S63, when it is determined that the transmission destination wait number in the reception frame is not smaller than the wait number of the local node, processing for which explanations have been given in reference to steps S69 to S73 is performed.

By employing a selection method of the relay destination and a routing method that have been explained so far, the sensor relay node 10 may transmit and receive a frame to and from a server 1 with a shortest number of hops. That is to say, as mentioned so far above, the core relay node 50 of the relay destination is determined by using the wait number, and the core relay node 50 that may be reached with the shortest number of hops from an individual sensor relay node 10 is selected as a relay destination. Further, a path to the core relay node 50 that was selected as a relay destination is set as a path with a shortest number of hops. The selection of the path at this time is performed on the basis of the transmission destination wait number in the reception frame, the wait number of the local node, and the wait number of the connection destination node for each port. Further, in a method according to the present embodiment, since the core relay node 50 that may be reached with a shortest number of hops by a sensor relay node 10 is designated as a relay destination, a concentration of processing to a specific core relay node 50 may be prevented.

### Second Embodiment

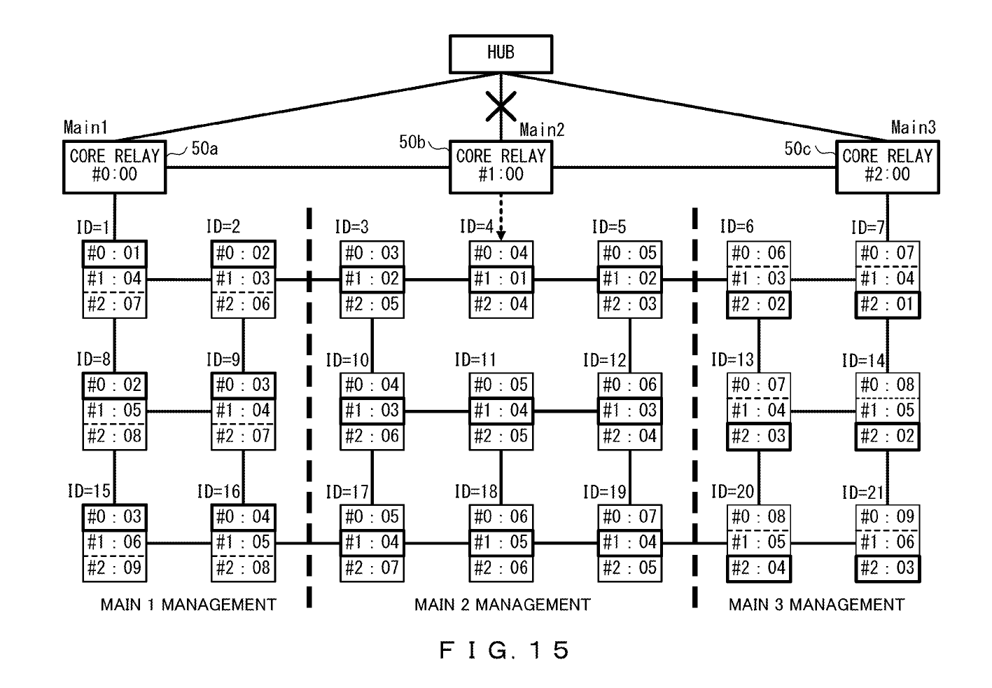

In the second embodiment, explanations are given for a method for restoration, when a problem has occurred between the core relay node 50 and the server 1. FIG. 15 illustrates an example when a problem has occurred on a line between the core relay node 50b and the server 1 under a state in which the relay destination is decided as illustrated in FIG. 10. Hereafter, explanations are given for processing that is performed when a problem has occurred as illustrated in FIG. 15, as an example. In the second embodiment, a routing of a frame after the relay destination has been decided is performed similarly to the first embodiment.

A procedure Pr 21 is as follows. When a problem occurs on a line between the core relay node 50b and the server 1, the core relay node 50 detects an occurrence of a problem. The core relay node 50b may determine that a problem has occurred between the server 1 and the core relay node 50b when, for example, a signal is transmitted and received to and from the server 1 on a regular basis and when a signal could not be received from the server 1 for more than a prescribed time period.

A procedure Pr 22 is as follows. The core relay node 50b specifies that the adjacent sensor relay node 10 is the node N4. The processing is performed, for example, as the core relay node 50b specifies a sensor relay node 10 in which it has been reported that the wait number to the sensor relay node 10b is 1 by the synchronization request response frame in the above mentioned procedure Pr 19. The core relay node 50b requests of the node N4 that the wait number designating the core relay node 50b as a starting point be changed to the initial value (0xFF). At this time, it is presupposed that the core relay node 50b reports to the node N4 the core relay number=1 of the core relay node 50b as well.

A procedure Pr 23 is as follows. The wait number of the node N4, before the problem between the core relay node 50b and the server 1 is reported, is as follows.

The wait number in which a core relay node 50a is designated as a starting point: 4

The wait number in which a core relay node 50b is designated as a starting point: 1

The wait number in which a core relay node 50c is designated as a starting point: 4

When the node N4 receives the request of a change of the wait number from the core relay node 50b, the wait number generation unit 32 of the node N4 initializes the wait number in response to the request. With the processing, the wait number of the node N4 is as follows.

The wait number in which a core relay node 50a is designated as a starting point: 4

The wait number in which a core relay node 50b is designated as a starting point: 0xFF

The wait number in which a core relay node 50c is designated as a starting point: 4

A procedure Pr 24 is as follows. The selection unit 35 of the node N4 compares the wait numbers and decides the core relay node 50 of the relay destination. A method for deciding the core relay node 50 of the relay destination is similar to a method for which explanations have been given in reference to FIG. 14. With this processing, the selection unit 35 selects the core relay node 50a as a relay destination.

A procedure Pr 25 is as follows. The selection unit 35 of the node N4 transmits a status notification frame to the core relay node 50a. An example of a status notification frame is illustrated in F5 of FIG. 7. It is presupposed that in the status notification frame, a value of a KIND field is set as KIND 5. Further, an address of the status notification frame is a core relay node 50 which is set as a new relay destination and the transmission destination wait number is set as 0. A transmission source wait number is a wait number of the sensor relay node 10 which transmits a status notification. In this example, a transmission source wait number is set as 4 and a destination address is set as an address of a core relay node 50a. Further, in the status notification frame, the transmission source core relay number is included. The selection unit 35 sets the value of the transmission source core relay number as 0.

A selection unit 35 specifies that the sensor relay node 10 that is more approximate to a core relay node 50a than a node N4 is a node N3, as it checks the wait number table 33 associated with the core relay node 50a which is set as a new relay destination. Accordingly, the selection unit 35 requests of a transmitter 22 that a transmission be made via a port connected to the node N3 and reports that the relay destination has been changed to a core relay node 50a.

A procedure Pr 26 is as follows. When the routing unit 38 of the node N3 recognizes that a KIND field of the reception frame is KIND 5, it recognizes that it has received a status notification frame. Since a status notification frame is a frame for reporting the change of the relay destination, it is possible that the core relay node 50 that is different from the relay destination of the local node is set as an address. Therefore, the routing unit 38 obtains a transmission source core relay number in the status notification frame without referring to an FID table 27 or a PS table 28 of a node N3 and decides a transfer destination on the basis of a wait number table 33 that was associated with the obtained transmission source core relay number. Here, since a status notification frame of a transmission source core relay number=0 is received, the routing unit 38 recognizes a port to which a wait number that is smaller than the node N3 is assigned as it checks the wait number table 33 of the core relay node 50a. The routing unit 38 transfers a status notification frame to the node N2 by outputting the status notification frame from the recognized port.

Similarly to the above, a routing unit 38 performs transfer processing in the node N2, and transfers a status notification frame to a node N1. The node N1 transfers a status notification frame to the core relay node 50a. The core relay node 50a adds the node N4 to a management target node on the basis of the received status notification frame. Further, reporting to the server 1 that the node N4 has become a new management target of the core relay node 50a makes a server 1 recognize that, hereafter, a core relay node 50a relays the frame addressed to the node N4.

A procedure Pr 27 is as follows. By transmitting a health frame (F3 in FIG. 7) to adjacent nodes N3 and N5, an initialization request unit 37 of the node N4 reports the change of the wait number. Here, the initialization request unit 37 sets a transmission source core relay number of a health frame as 1 and sets a transmission source wait number as 0xFF.

A procedure Pr 28 is as follows. Before receiving a health frame from the node N4, the wait number of the node N3 is as follows.

The wait number in which a core relay node 50a is designated as a starting point: 3

The wait number in which a core relay node 50b is designated as a starting point: 2

The wait number in which a core relay node 50c is designated as a starting point: 5

A node N3 recognizes that a wait number of the node N4 in which a core relay node 50b is designated as a starting point has been changed to 0xFF as the node N3 analyzes a received health frame. Further, the wait number generation unit 32 of the node N3 changes the wait number in which a core relay node 50b is designated as a starting point to 0xFF (initial value). That is to say, the wait number generation unit 32 changes the wait number as follows.

The wait number in which a core relay node 50a is designated as a starting point: 3

The wait number in which a core relay node 50b is designated as a starting point: 0xFF

The wait number in which a core relay node 50c is designated as a starting point: 5

A procedure Pr 29 is as follows. A selection unit 35 of the node N3 decides the core relay node 50 of the relay destination by using the wait number that has been changed. A method for deciding the core relay node 50 of a relay destination or a method for reporting the change of the relay destination is similar to procedures Pr 24 to Pr 26. Further, the node N3 transmits to the adjacent nodes N2 and N10 a health frame and reports that the wait number in which a core relay node 50b is designated as a starting point has been changed.

A procedure Pr 30 is as follows. In the node N5, the change of a wait number in which a core relay node 50b is designated as a starting point and a transmission of a status notification frame are performed as well. The processing is similar to the operations that have been explained in the procedures Pr24 to Pr27. In other nodes, the change of the wait number is performed and when the core relay node 50 of the relay destination is changed along with the change of the wait number, processing is performed similarly to procedures Pr24 to Pr27. On the other hand, when the core relay node 50 of the relay destination is not changed even when the wait number has been changed, a status notification frame is not generated. However, even when the core relay node 50 of the relay destination is not changed, it is reported to the adjacent nodes by a health frame that the wait number has been changed.

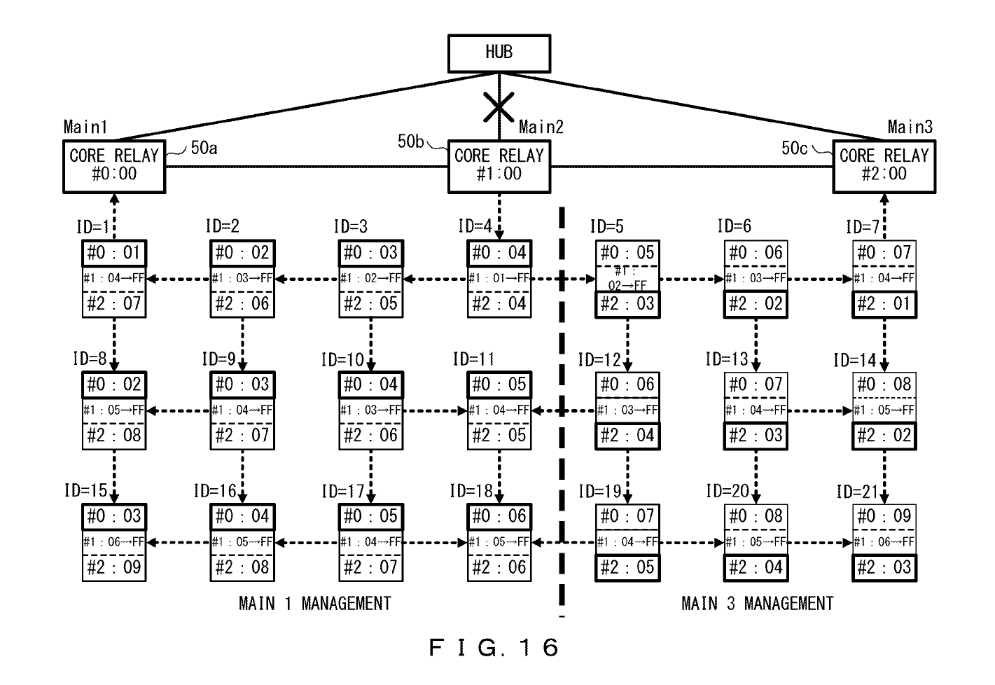

FIG. 16 illustrates a relay destination of each sensor relay node 10 after processing of procedures Pr21 to Pr 30 is performed. As illustrated in FIG. 16, nodes N3, N4, N10, N11, N17, and N18 change a relay destination from a core relay node 50b to a core relay node 50a. Nodes N5, N12, and N19 change a relay destination from a core relay node 50b to a core relay node 50c.

In the second embodiment, in reference to FIG. 13A, FIG. 13B, and FIG. 13D, explanations are given for an example of operations of the sensor relay node 10 that has received a health frame. When the health frame has been received, processing of steps S1 to S3 of FIG. 13A is performed in a sensor relay node 10, and it is determined as No in step S3. The processing of steps S1 to S3 is as explained above. Upon a determination of No in step S3, processing moves on to step S21 of FIG. 13B, and it is determined whether or not a health frame has been received. Here, since a health frame has been received, in step S22, a wait number of the connection destination of a port that received the health frame is changed on the basis of the transmission source wait number in the health frame. Processing of steps S23 and S24 is further performed. The processing of steps S23 and S24 is as explained above.

In step S24, when it is determined that a transmission source wait number of the received health frame is an initial value, processing of FIG. 13D is performed. First, the wait number generation unit 32 initializes a wait number of a local node in which a core relay node 50 designated as a relay destination is designated as a starting point (step S41). Further, the wait number generation unit 32 initializes a value of a master port in a wait number table 33 that was associated with a core relay node 50 that is designated as a relay destination (step S42). After that, the sensor relay node 10 transmits a health frame from all ports (step S43). Further, the sensor relay node 10 decides the core relay node 50 to be designated as a relay destination on the basis of the wait number that has been changed, and when the core relay node 50 has been changed, the sensor relay node 10 transmits a status notification frame to the core relay node 50 that has been designated as a new relay destination (step S44).

As mentioned above, when a problem has occurred on a line between a core relay node 50 and a server 1, a wait number is changed in an individual sensor relay node 10 upon the notification from a core relay node 50. Further, the individual sensor relay node 10 decides the core relay node 50 of a relay destination on the basis of the wait number that has been changed and reports to a designated core relay node 50 as a new relay destination that the relay destination has been changed to this core relay node 50, when the relay destination has been changed. Accordingly, a scheme that autonomously recovers from a problem even when a problem occurs may be provided and routing with a shortest number of hops may be performed by designating a core relay node 50 as a relay destination which any sensor relay node 10 may reach with a shortest number of hops.

### Third Embodiment

In a third embodiment, explanations are given for operations performed when a problem has occurred in a core relay node 50. Hereafter, explanations are given for processing when a problem has occurred at the core relay node 50b, under a state in which a relay destination is selected as illustrated in FIG. 10. In the third embodiment, routing of a frame after a relay destination has been decided is performed similarly to the first embodiment.

A procedure Pr 41 is as follows. When a failure occurs in a core relay node 50b, a node N4 that is adjacent to the core relay node 50b does not transmit and receive a health frame to and from the core relay node 50b. When the health frame is not received for more than a prescribed time period from the core relay node 50b, the problem detection unit 36 of the nodes N4 judges that the core relay node 50b has failed.

A procedure Pr 42 is as follows. A problem detection unit 36 reports to a wait number generation unit 32 and an initialization request unit 37 that the core relay node 50b has failed. The wait number generation unit 32 initializes a wait number in which a core relay node 50b is designated as a starting point. The initialization request unit 37 makes a request to the adjacent sensor relay node 10 to initialize a wait number in which a core relay node 50b is designated as a starting point. Processing performed hereafter is similar to the processing of the procedure (Pr 24) and after of a second embodiment.

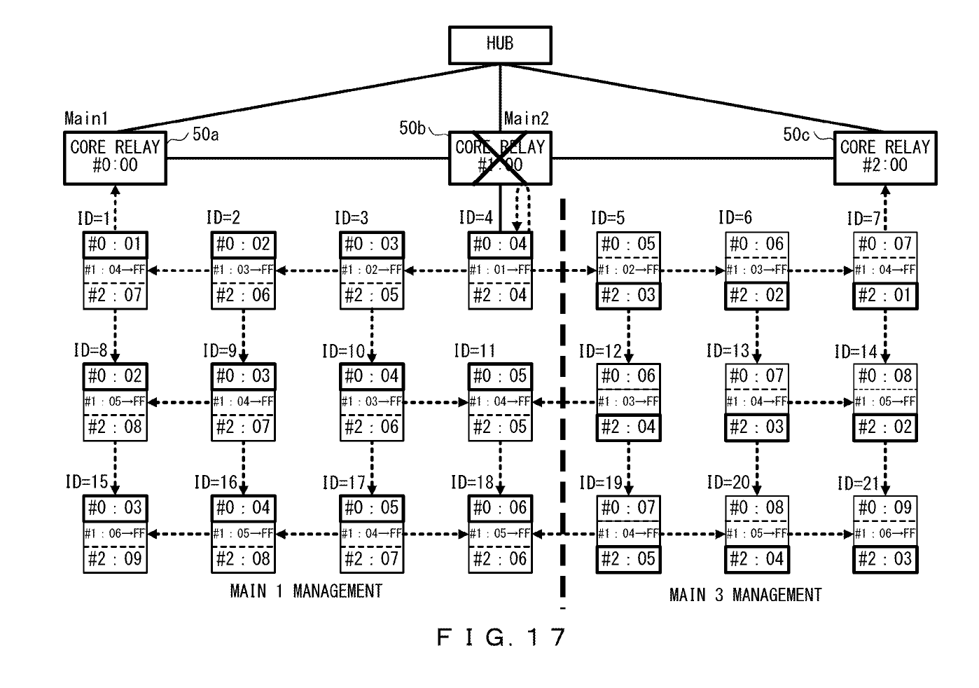

An example of a core relay node 50 of a relay destination that has been changed when a failure of the core relay node 50 was found is illustrated in FIG. 17. As illustrated in FIG. 17, a path or relay destination may also be changed autonomously when a failure of the core relay node 50 has been found, as the sensor relay node 10 which is adjacent to the core relay node 50 monitors the operation of the core relay node 50 by using a health frame.

### Fourth Embodiment

Next, explanations are given for processing when a problem has occurred in the sensor relay node 10. Hereafter, explanations are given for processing when a problem has occurred in the sensor relay node 10 of the node N5, under a state in which a relay destination is selected, as illustrated in FIG. 10.

A procedure Pr 51 is as follows. When a problem occurs in a node N5, the nodes N4, N12, and N6 that are adjacent to the node N5 do not transmit and receive a health frame to and from the node N5. When the health frame is not received for more than a prescribed time period from the node N5, the problem detection units 36 of the nodes N4, N12, and N6 judge that the adjacent sensor relay node 10 has failed.

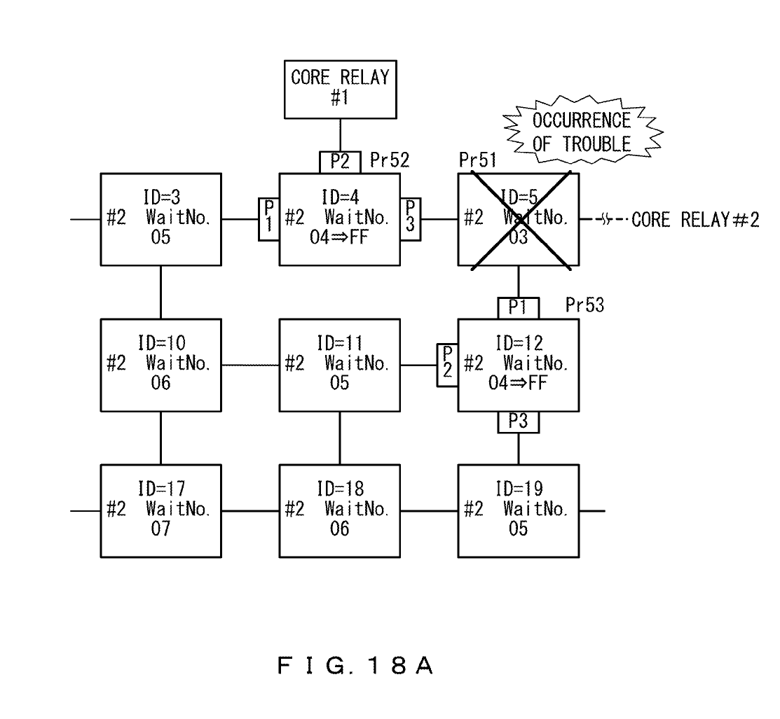

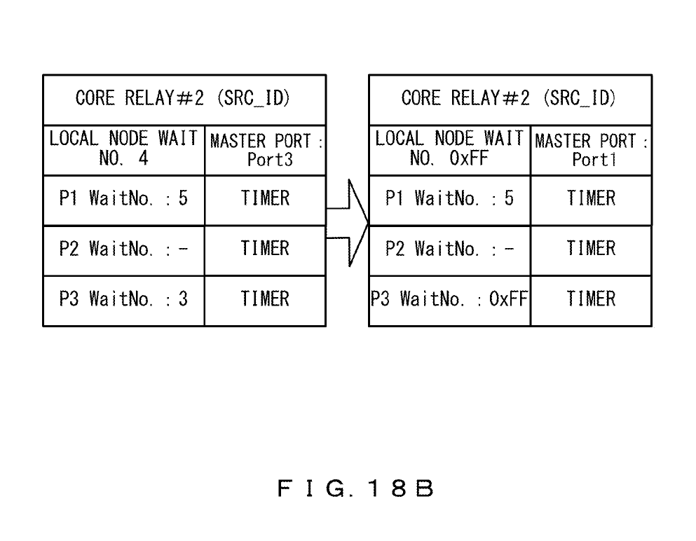

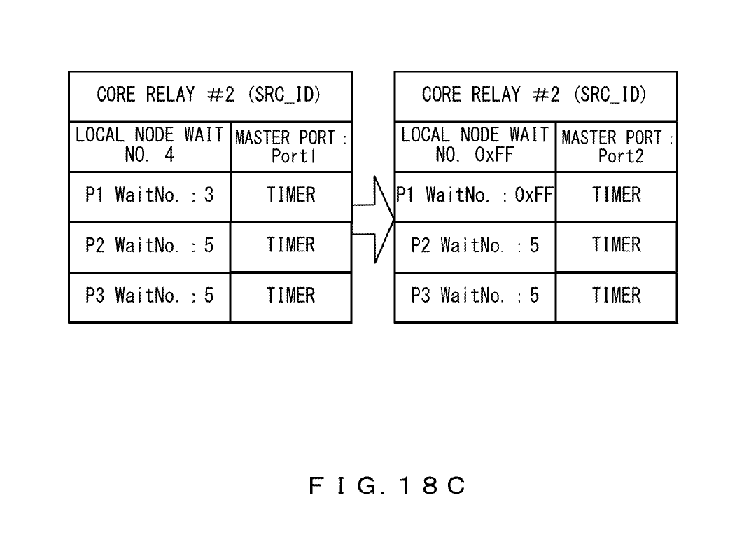

A procedure Pr 52 is as follows. When a problem detection unit 36 judges that an adjacent sensor relay node 10 has failed, the problem detection unit 36 specifies a port that does not receive a health frame. For example, as illustrated in FIG. 18A, when the node N5 is connected to a port P3 of the node N4, the problem detection unit 36 of the node N4 obtains the wait number of the node which is connected to the port P3 from the wait number table 33 and compares the above mentioned wait number with the wait number of the node N4. Further, the problem detection unit 36 initializes the wait number when a wait number that is larger than that of the failed node is set in a comparison result. That is to say, the problem detection unit 36 initializes a wait number in which a core relay node 50 with which the local node may communicate via the failed node is designated as a starting point.

For example, although the wait number in which a core relay node 50a is designated as a starting point is 4 at the node N4, the wait number in the node connected to the port P1 is 5. Similarly, although the wait number in which a core relay node 50b is designated as a starting point is 1 at the node N4, the wait number in the node connected to the port P1 is 2. Further, the wait number in which a core relay node 50c is designated as a starting point is 4 at the node N4, while the wait number in the node connected to the port P1 is 3. In this case, although the node N4 may communicate with core relay nodes 50a and 50b without the node N5 therebetween, the core relay node 50c is accessed via the node N5 with the shortest number of hops. However, since the node N5, which is the intermediary node, has failed, the problem detection unit 36 initializes the wait number in which a core relay node 50c is designated as a starting point so as not to designate the core relay node 50c as a relay destination. In the node N4, the wait number table 33 in which the core relay node 50c is designated as a starting point is updated as illustrated in FIG. 18B.

A procedure Pr 53 is as follows. In the node N12, all wait numbers in which any core relay node 50 of core relay nodes 50a to 50c is designated as a starting point are larger than the node N5. Therefore, in the node N12, any wait number in which any core relay node 50 of core relay nodes 50a to 50c is designated as a starting point is initialized. In the node N12, the wait number table 33 in which a core relay node 50c is designated as a starting point is undated as illustrated in FIG. 18C.

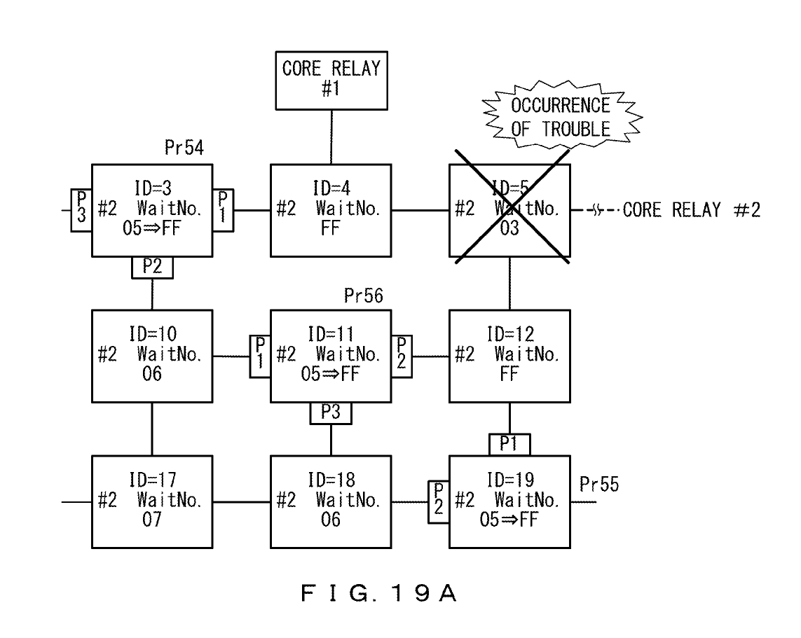

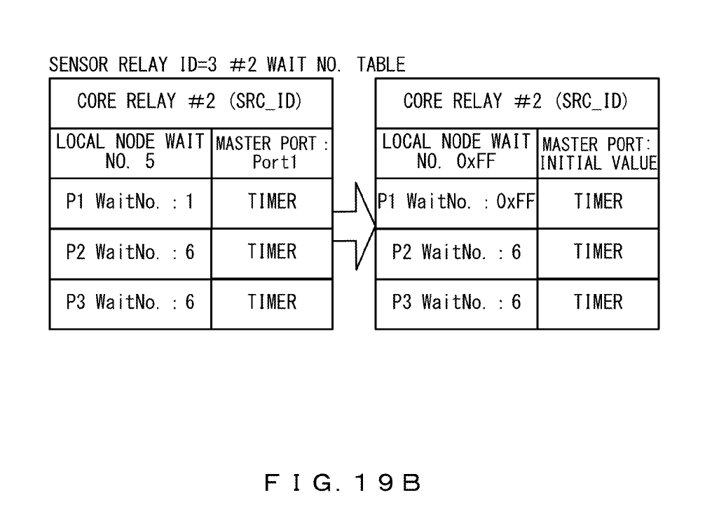

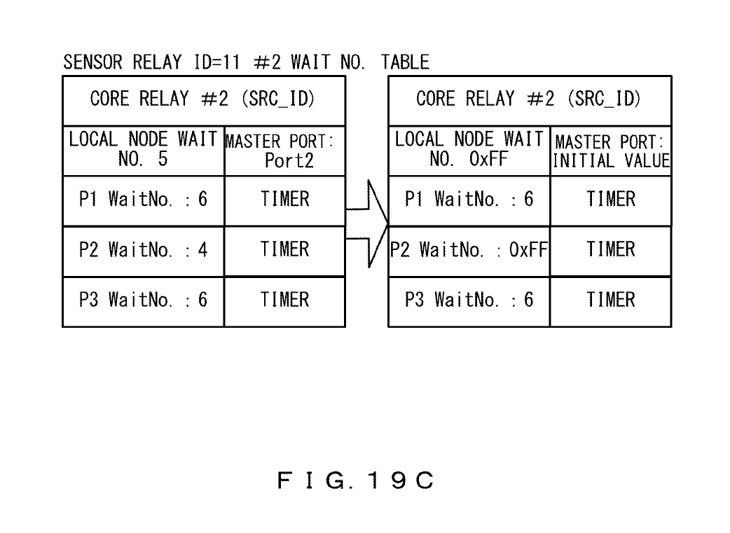

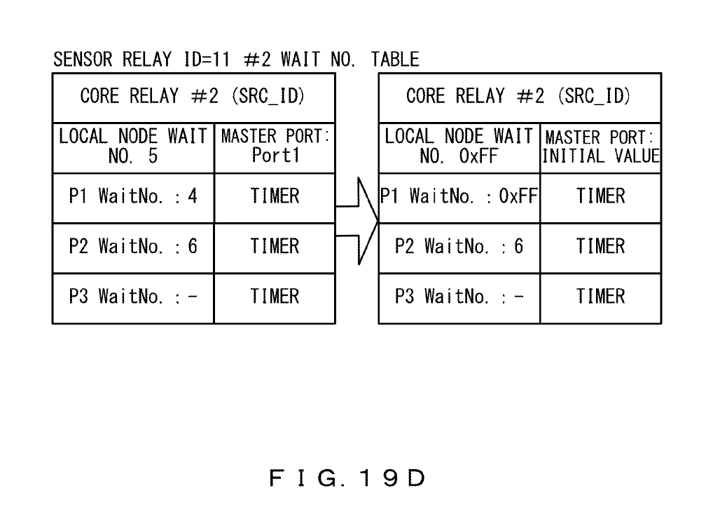

A procedure Pr 54 is as follows. An initialization request unit 37 of the node N4 makes a request for initialization in order to prevent a request to transmit the frame via a failed node from being made. When the wait number in which the core relay node 50 is designated as a starting point that is identical to the starting point of the wait number which has been initialized at the problem detection unit 36 is larger than a wait number which was set in the local node, the initialization request unit 37 makes a request to initialize the wait number. For example, since the node N4 has initialized the wait number in which a core relay node 50c is designated as a starting point, the initialization request unit 37 checks the wait number table 33 associated with the core relay node 50c. The initialization request unit 37 makes a request, of the wait number table 33 associated with the core relay node 50c, to initialize the wait number in which a core relay node 50c is designated as a starting point from the port in which a wait number that is larger than the wait number of the node N4 before initialization is set. In an example of FIG. 19A, the initialization request unit 37 of the node N4 makes a request to the node N3 to initialize the wait number in which a core relay node 50c is designated as a starting point.

A wait number generation unit 32 of the node N3, when it receives a request to initialize the wait number in which a core relay node 50c is designated as a starting point, initializes the wait number, in response to the request. The wait number table 33 in which a core relay node 50c is designated as a starting point in the node N3 is updated as illustrated in FIG. 19B. Further, the wait number generation unit 32 reports to the initialization request unit 37 that it has received a request to initialize the wait number in which a core relay node 50c is designated as a starting point and the wait number before initializing the node N3 in which a core relay node 50c is designated as a starting point.

A procedure Pr 55 is as follows. Similarly to the node N4, the node N12 makes a request for initialization. Accordingly, in the node N12, a request to initialize the wait number in which core relay nodes 50a to 50c are designated as starting points is made of the node N19. An example of a change in the wait number table 33 in which a core relay node 50c is designated as a starting point in the node N19 is illustrated in FIG. 19D. Processing similar to the node N3 is performed in the node N19 as well.

A procedure Pr 56 is as follows. The node N12 makes a request to the node N11 to initialize the wait number in which core relay nodes 50b and 50c are designated as starting points. An example of a change in the wait number table 33 in which a core relay node 50c is designated as a starting point in the node N11 is illustrated in FIG. 19C. Processing similar to the node N3 is performed in the node N11 as well.

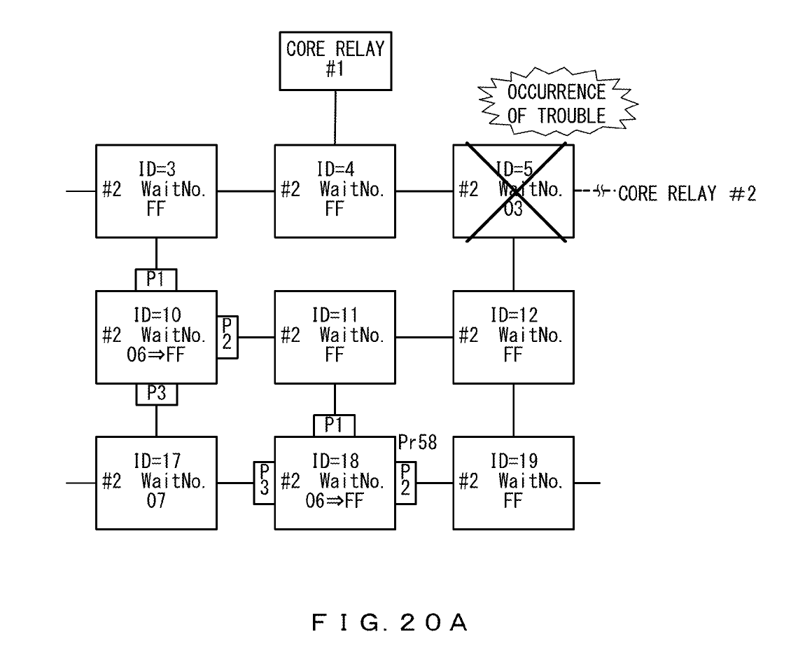

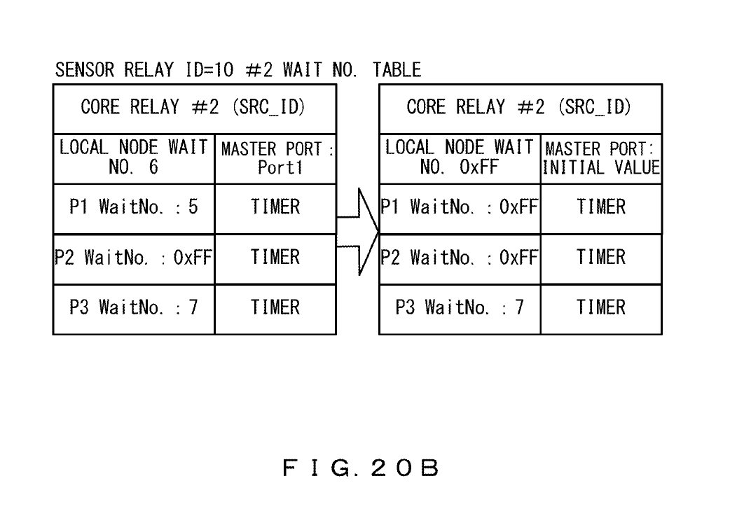

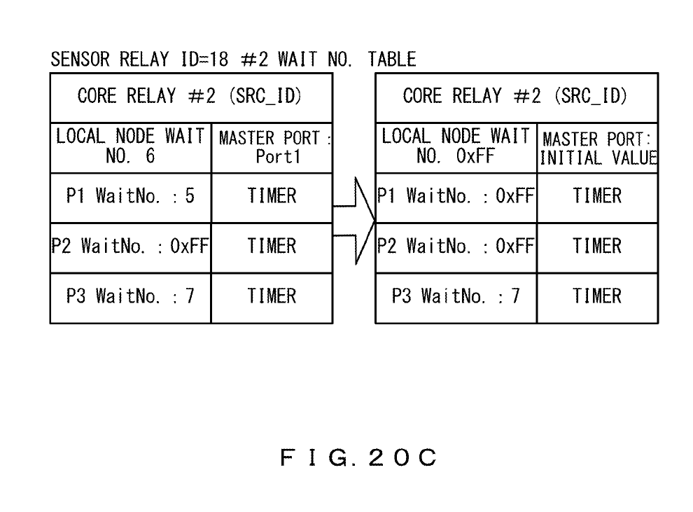

A procedure Pr 57 is as follows. An initialization request unit 37 of the node N3 compares the wait number of the node of the output destination of each port with the wait number that was decided before initializing the local node associated with the wait number table 33 associated with the core relay node 50c. As a result of a comparison, the initialization request unit 37 outputs the request for initialization from the port connected to the node of the wait number that is larger than the wait number before initialization of the local node. Here, the node N3 makes a request to the nodes N2 and N10 to initialize the wait number in which the core relay node 50c is designated as a starting point. FIG. 20A illustrates a case in which a request for initialization is made to the node N10. Further, FIG. 20B illustrates an example of a change in the wait number table 33 in which a core relay node 50c is designated as a starting point in the node N10.

A procedure Pr 58 is as follows. An initialization request unit 37 of the node N11 makes a request to the node N18 to initialize the wait number in which core relay nodes 50a to 50c are designated as starting points after the initialization request unit 37 performs processing that is similar to processing for the node N3. The initialization request unit 37 of the node N19 also makes a request to the node N18 to initialize the wait number in which core relay nodes 50a and 50b are designated as starting points. FIG. 20C illustrates an example of a change in the wait number table 33 in which a core relay node 50c is designated as a starting point in the node N18.

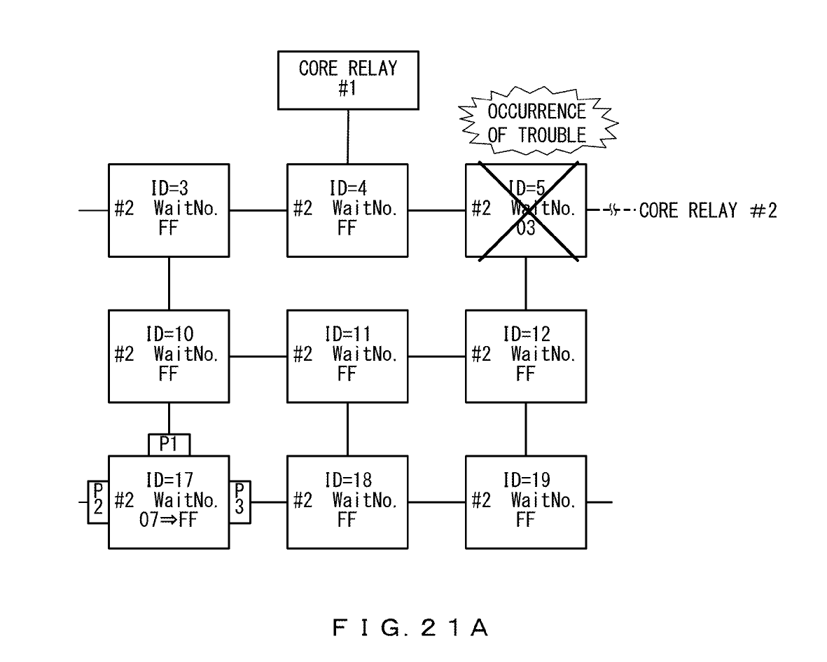

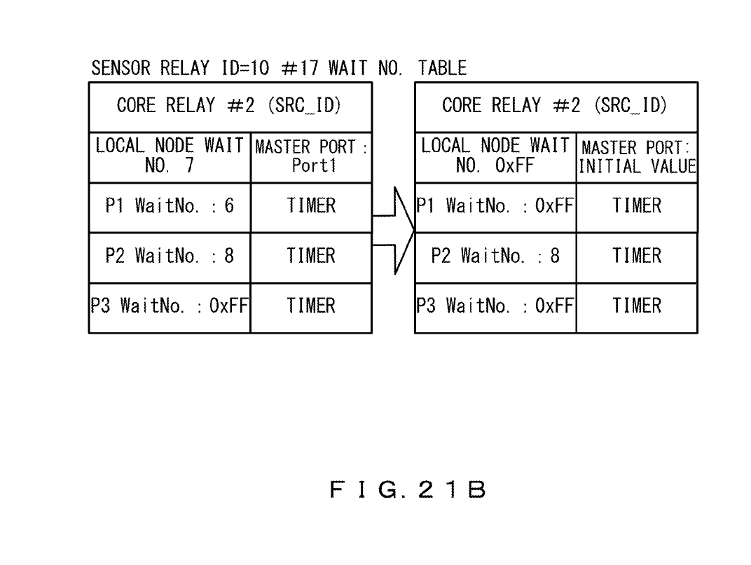

A procedure Pr 59 is as follows. The node 17 changes the wait number table 33 as illustrated in FIG. 21A when it receives a request for initialization from the nodes N10 and N18. FIG. 21B illustrates an example of a change in the wait number table 33 in which a core relay node 50c is designated as a starting point in the node N17.

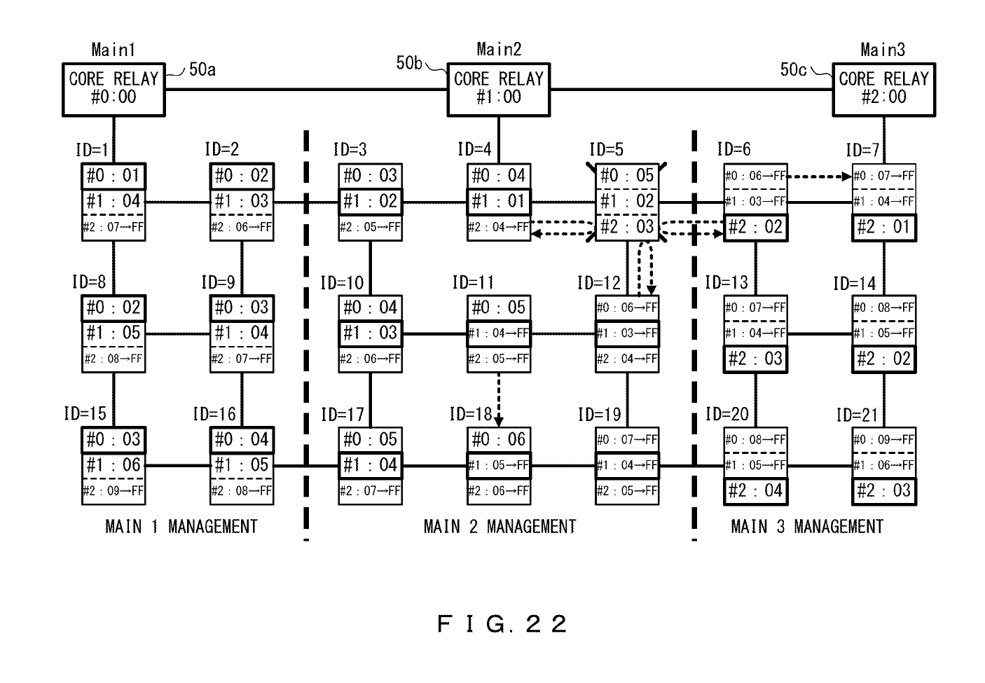

A procedure Pr 60 is as follows. The change in the wait number is also performed in another sensor relay node 10. As a result, as illustrated in FIG. 22, the wait number is changed. In FIG. 22, a value which is at the left side of an arrowhead indicates the wait number assigned to each sensor relay node 10 before a problem in the node N5 occurs and a value which is to the right side of an arrow head indicates the wait number decided by the occurrence of a problem in the node N5.

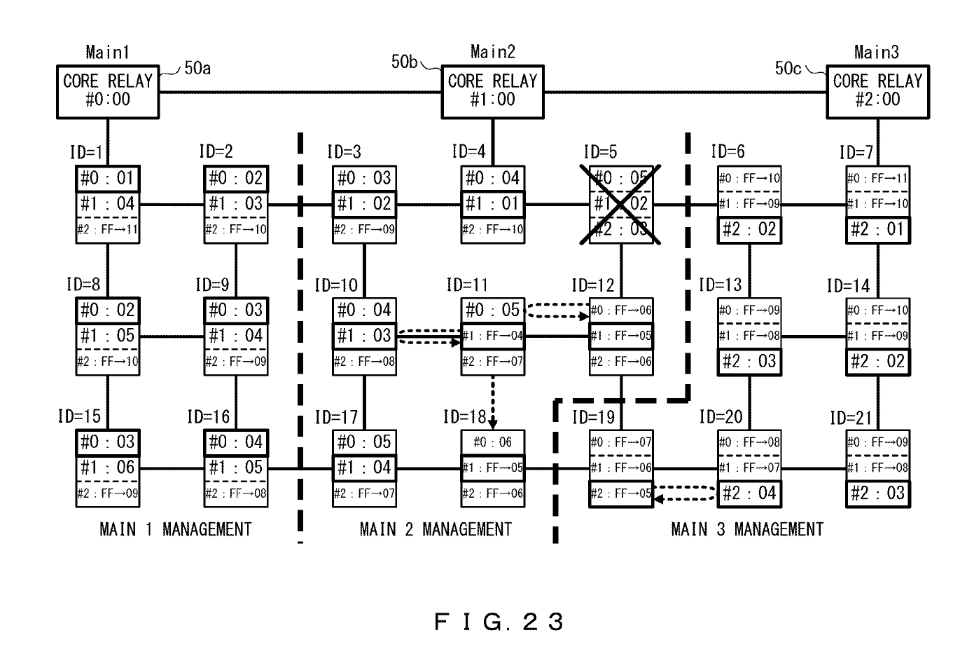

A procedure Pr 61 is as follows. When the transmission source wait number that is included in the health frame is not an initial value, the sensor relay node 10 that received a health frame changes the wait number of the local node on the basis of the received wait number. A method for changing the wait number on the basis of the transmission source wait number that is included in the frame is similar to the method for which explanations have been given in reference to steps S25 to S29 in FIG. 13B. For example, when the wait number in which the core relay node 50a is designated as a starting point from the node N11 is 5, a wait number generation unit 32 of the node N12 decides the wait number of the node N12 in which the core relay node 50a is designated as a starting point as 6. An example of a change in the wait number is illustrated in FIG. 23.

A procedure Pr 62 is as follows. In accordance with the wait number that has been changed in the procedure Pr 61, the selection unit 35 decides the core relay node 50 of the relay destination. A method for selecting the core relay node 50 of the relay destination is similar to the method for which explanations have been given in reference to FIG. 14. Further, a method for reporting to the core relay node 50 that a new relay destination has been designated when the relay destination has been changed is similar to the second embodiment. In this example, by the processing of the procedure Pr 61, the node N19 changes its relay destination from the core relay node 50b to the core relay node 50c.

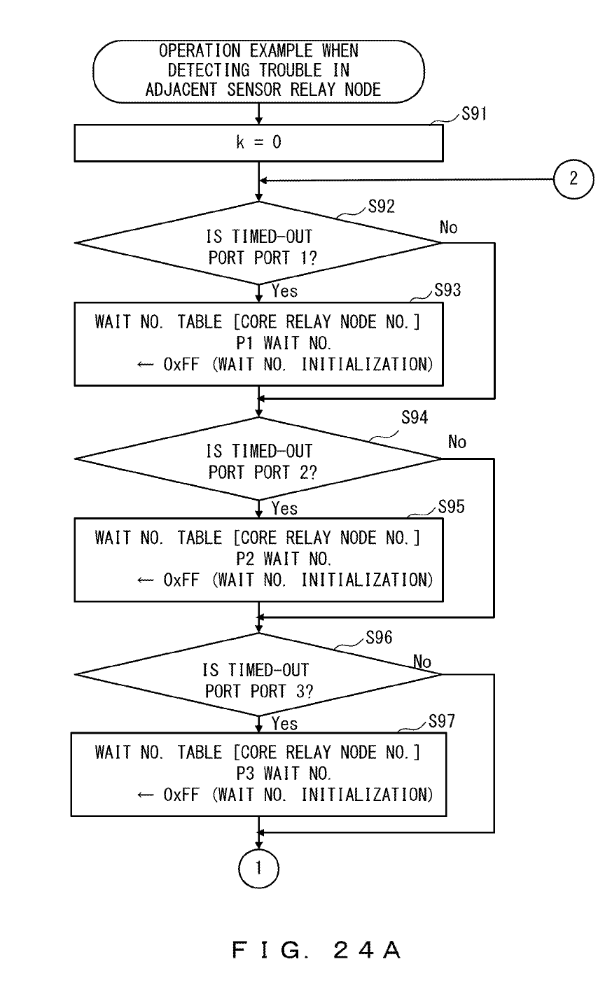

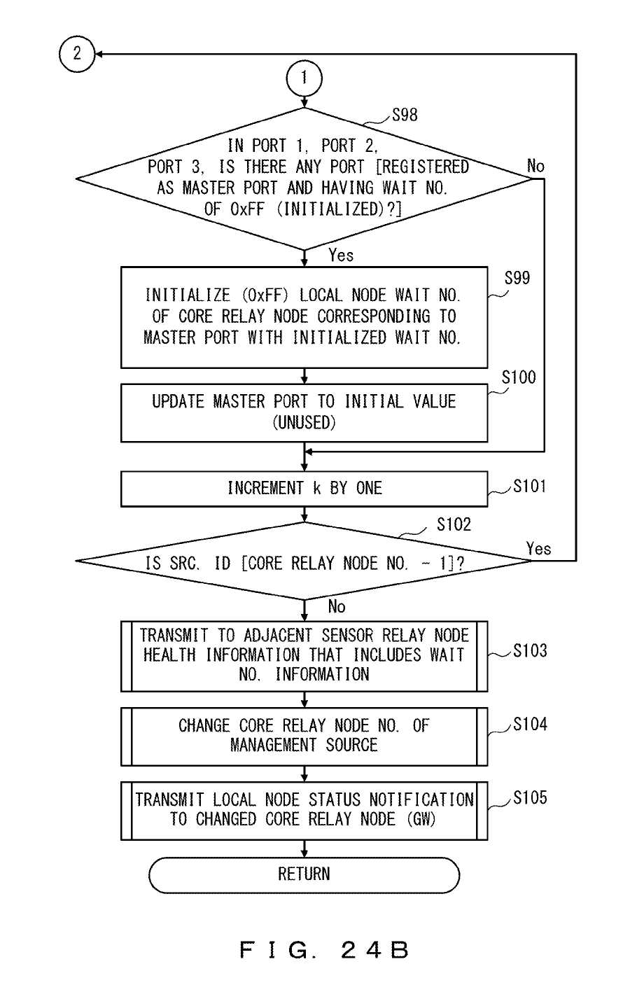

FIG. 24A and FIG. 24B respectively illustrate a flowchart which explains an example of an operation of a sensor relay node 10 when an adjacent sensor relay node 10 has failed. Processing illustrated in FIG. 24A and FIG. 24B is one example, and it is appreciated that orders of a combination of steps S92 and S93, a combination of steps S94 and S95, and a combination of steps S96 and S97 may be changed arbitrarily. The problem detection unit 36 judges that the node connected to the timed-out port has failed when no transmission and reception of the frame is performed until the timer of the wait number table 33 becomes timed-out. Accordingly, the problem detection unit 36 sets a variable k for counting the number of the core relay node 50 that is set as a processing target as 0 (step S91). The problem detection unit 36 checks whether or not a timed-out timer was associated with the port P1 (step S92). When the timer associated with the port P1 has been timed-out, the problem detection unit 36 initializes the wait number of the node that is connected to the port P1 in the wait number table 33 of the core relay number=k (Yes in step S92, step S93). On the other hand, when the timer associated with the port P1 has not been timed-out, the wait number of the node connected to the port P1 is not updated.

Next, the problem detection unit 36 checks whether or not a timed-out timer was associated with the port P2 (step S94). When the timer associated with the port P2 has been timed-out, the problem detection unit 36 initializes the wait number of the node that is connected to the port P2 in the wait number table 33 of the core relay number=k (Yes in step S94, step S95). Further, the problem detection unit 36 checks whether or not a timed-out timer has been in association with the port P3 (step S96). When the timer in association with the port P3 has been timed-out, the problem detection unit 36 initializes the wait number of the node that is connected to the port P3 in the wait number table 33 of the core relay number=k (Yes in step S96, step S97).

Next, the problem detection unit 36 checks whether or not the wait number has been initialized by the port that was set as the master port (step S98). That the wait number has been initialized in the master port means that a shortest number of hops is changed. Accordingly, when the wait number of the master port is initialized, the problem detection unit 36 initializes the wait number of the local node in which the core relay node 50 of the core relay number=k is designated as a starting point and also initializes a setting of a master port (steps S99, S100). After that, by incrementing a value of k by 1, the problem detection unit 36 compares a value of subtracting 1 from a total number of the core relay nodes 50 with a value of k (steps S101, S102). The processing of steps S91 to S102 is repeated until a value of subtracting 1 from a total number of the core relay nodes 50 matches up with a value of k. When the value of subtracting 1 from a total number of the core relay nodes 50 matches up with the value of k, the sensor relay node 10 transmits to the adjacent sensor relay node 10 a health frame which includes the wait number (step S103). When the initialization of the wait number or the re-decision of the wait number is completed by a transmission and reception of the health frame, the sensor relay node 10 re-decides the core relay node 50 of the relay destination by using the obtained wait number (step S104). Further, the sensor relay node 10 transmits a status notification frame to a core relay node 50 after a change (step S105). Upon reception of the frame, the core relay node 50 recognizes the change of the core relay node 50 that was performed in the sensor relay node 10.

As mentioned above, according to the present embodiment, even when a problem has occurred in the sensor relay node 10, the core relay node 50 which any normally operating sensor relay node 10 may reach with the shortest number of hops may be set as a relay destination, and routing with the shortest number of hops may be performed.

### Fifth Embodiment

Next, explanations are given for a method for setting a wait number in response to a request from the core relay node 50 when a problem has occurred in the sensor relay node 10.

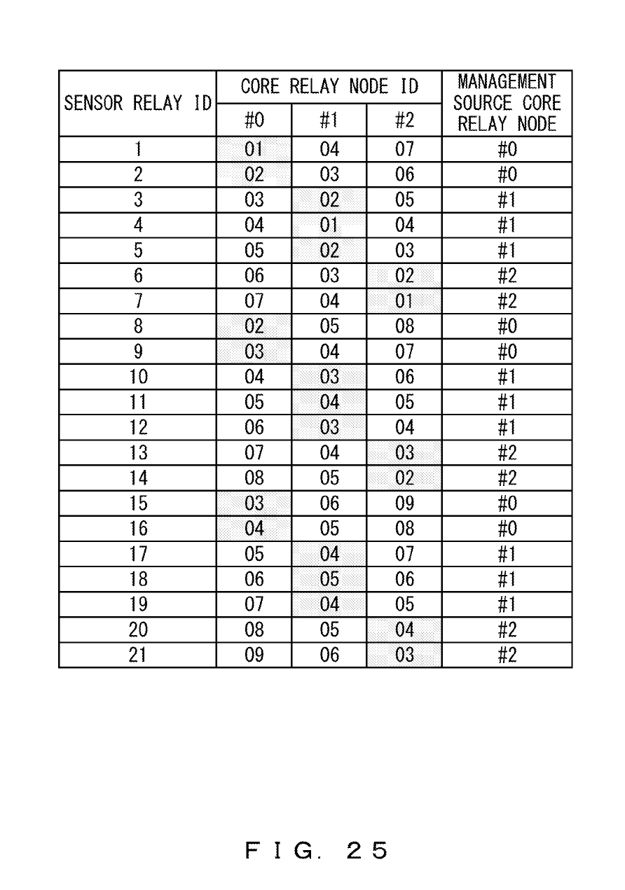

FIG. 25 illustrates an example of a table stored by a core relay node 50. In the present embodiment, as the core relay nodes 50 transmit and receive control information with each other, all the core relay nodes 50 store a common table. Accordingly, the core relay nodes 50 recognize the core relay node 50 for managing the sensor relay node 10 that is not a management target. For example, in FIG. 25, the core relay node 50a (core relay number=0) recognizes that the node N4 is managed by the core relay node 50b (core relay number=1). Further, when a problem has occurred in a certain sensor relay node 10, the core relay node 50 which has received information reporting that the problem has occurred informs another core relay node 50 of the occurrence of the problem together with an ID of the troubled sensor relay node 10 with the problem. When recognizing the notification in the sensor relay node 10, each core relay node 50 makes a request to re-decide the wait number. Each sensor relay node 10 decides the core relay node 50 of the relay destination in accordance with the re-decided wait number.

Hereafter, explanations are given for operations performed in the present embodiment by giving specific examples. Similarly to the above, explanations are given for the example of when a problem has occurred in the sensor relay node 10 of the node N5 under a state in which the relay destination is selected, as illustrated in FIG. 10.

A procedure Pr 71 is as follows. A detection that a problem has occurred in the node N5 is performed similarly to the procedure of the fourth embodiment (Pr 51). Accordingly, the nodes N4, N12, and N6 detect the occurrence of a problem in the node N5.

A procedure Pr 72 is as follows. The sensor relay node 10 that has detected the occurrence of a problem transmits a frame that reports the occurrence of a problem to the core relay node 50 which the sensor relay node 10 designates as a relay destination. A frame that reports the occurrence of a problem is a message which requests that the sensor relay node 10 in which a problem has occurred be deleted from the ad hoc network. Accordingly, in the following descriptions, the frame that reports the occurrence of a problem is described as “a deletion notification”. The sensor relay node 10 which has received a deletion notification transfers the deletion notification to the core relay node 50.

Here, the node N4 and the node N12 report to the core relay node 50b that a problem has occurred in the node N5. On the other hand, the node N6 reports to the core relay node 50c that a problem has occurred in the node N5.

A procedure Pr 73 is as follows. The core relay node 50b to which an occurrence of a problem has been reported reports to the core relay nodes 50a and 50c that a problem has occurred in the node N5. Similarly, the core relay node 50c, when it has received a deletion notification from the node N6, reports to the core relay nodes 50a and 50b that a problem has occurred in the node N5. Accordingly, each of the core relay nodes 50a to 50c in the network recognizes the occurrence of a problem in the node N5.

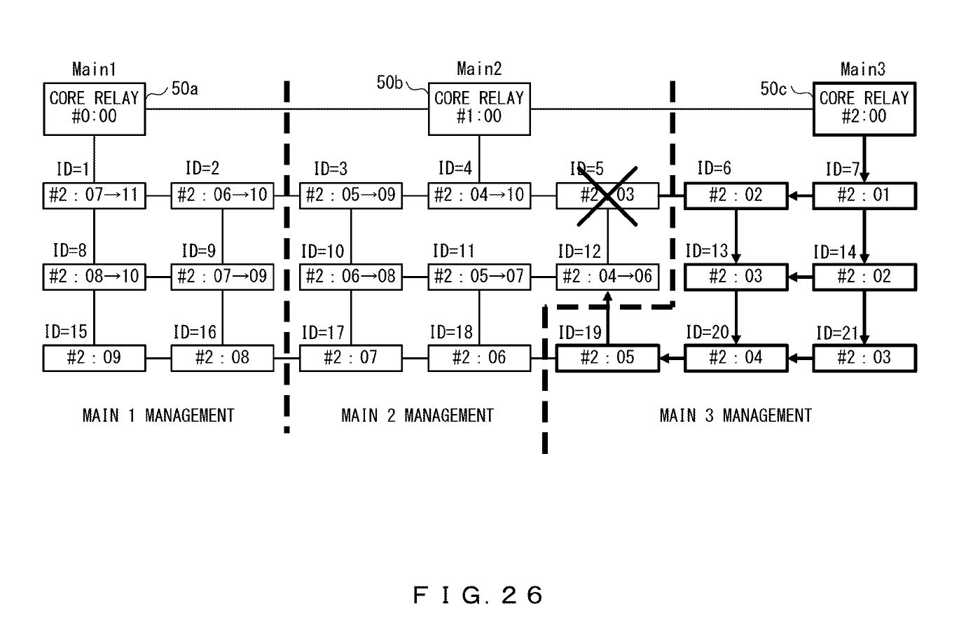

A procedure Pr 74 is as follows. When it is reported that a problem has occurred in the node N5, the core relay node 50 makes a request to reset the wait number to each sensor relay node 10 by using a synchronization request frame. A method for deciding the wait number is similar to the method for which explanations have been given in the first embodiment. However, since the problem occurs in the node N5 here, no synchronization request frame is output from the node N5. An example of when the wait number is re-decided on the basis of the synchronization request frame output from the core relay node 50c is illustrated in FIG. 26.

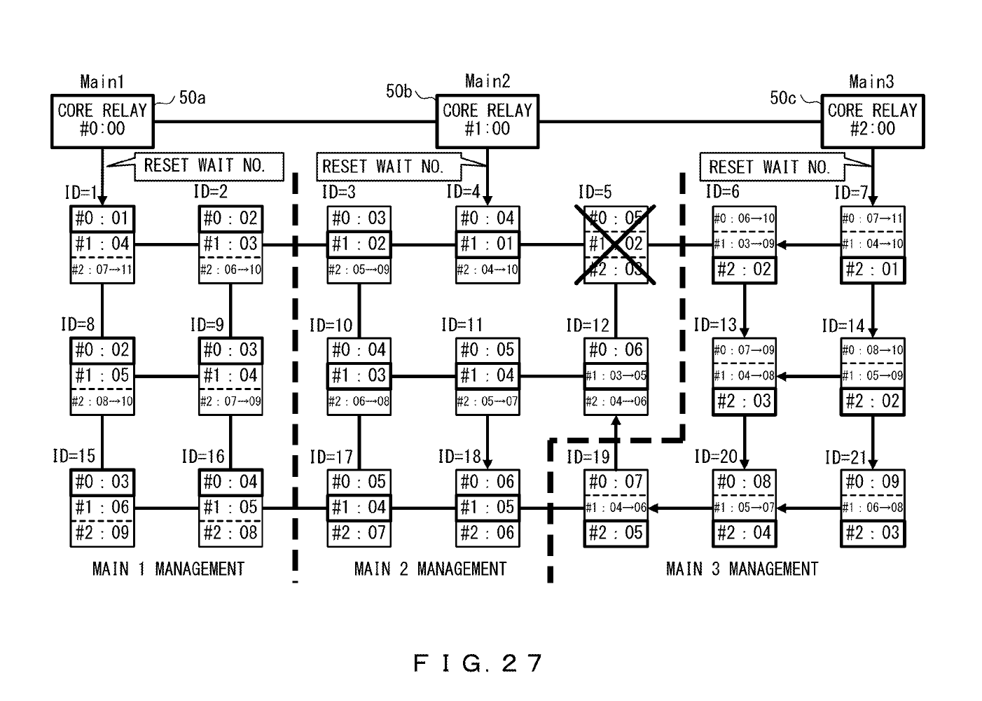

A procedure Pr 75 is as follows. The core relay nodes 50a and 50b make a request to re-decide the wait number as they output the synchronization request frame to the sensor relay node 10. FIG. 27 illustrates an example of when the wait number is re-decided under a state in which each of the core relay nodes 50a to 50c is designated as a starting point.

A procedure Pr 76 is as follows. When the wait number is decided, the selection unit 35 decides the core relay node 50 as a relay destination. A method for selecting the core relay node 50 of the relay destination is similar to the method for which explanations have been given in reference to FIG. 14. Further, a method for reporting to the core relay node 50 that a new relay destination has been designated when the relay destination has been changed is similar to the second embodiment. Since a path is changed on the basis of a problem of the node N5 in an example of FIG. 27, the node N19 changes the relay destination from the core relay node 50b to the core relay node 50c.

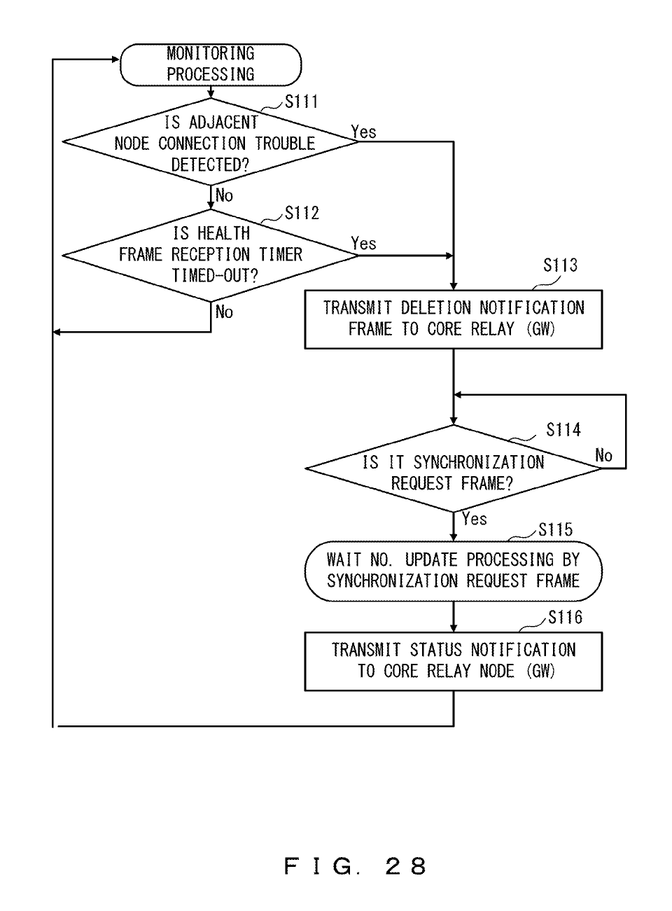

FIG. 28 is a flowchart which explains an example of an operation of a sensor relay node 10 in a fifth embodiment. The sensor relay node 10 determines whether or not it has detected an occurrence of a problem in an adjacent sensor relay node 10 (step S111). When the sensor relay node 10 has not detected an occurrence of a problem in the adjacent sensor relay node 10, it determines whether or not a health frame was received from the adjacent sensor relay node 10 before a timeout (No in step S111 and step S112). When the sensor relay node 10 receives the health frame before a timeout, it goes back to the processing of step S111 (Yes in step S112). When the sensor relay node 10 does not receive the health frame before a timeout, it transmits a deletion notification to the core relay node 50 (No in step S112, step S113). Here, in the deletion notification, an identifier that identifies a sensor relay node 10 that did not receive the health frame is included. Similarly, when the sensor relay node 10 has detected an occurrence of a problem in an adjacent sensor relay node 10 in step S111, it transmits a deletion notification to the core relay node 50 (Yes in step S111, step S113). After that, the sensor relay node 10 waits until it receives a synchronization request frame from the core relay node 50 (step S114). When the sensor relay node 10 receives a synchronization request frame, it re-decides the wait number (step S115). A re-decision of the wait number is performed similarly to the case in which the wait number is decided in the first embodiment. Then, the sensor relay node 10 decides the core relay node 50 of the relay destination on the basis of the re-decided wait number, and transmits a status notification frame (step S116).

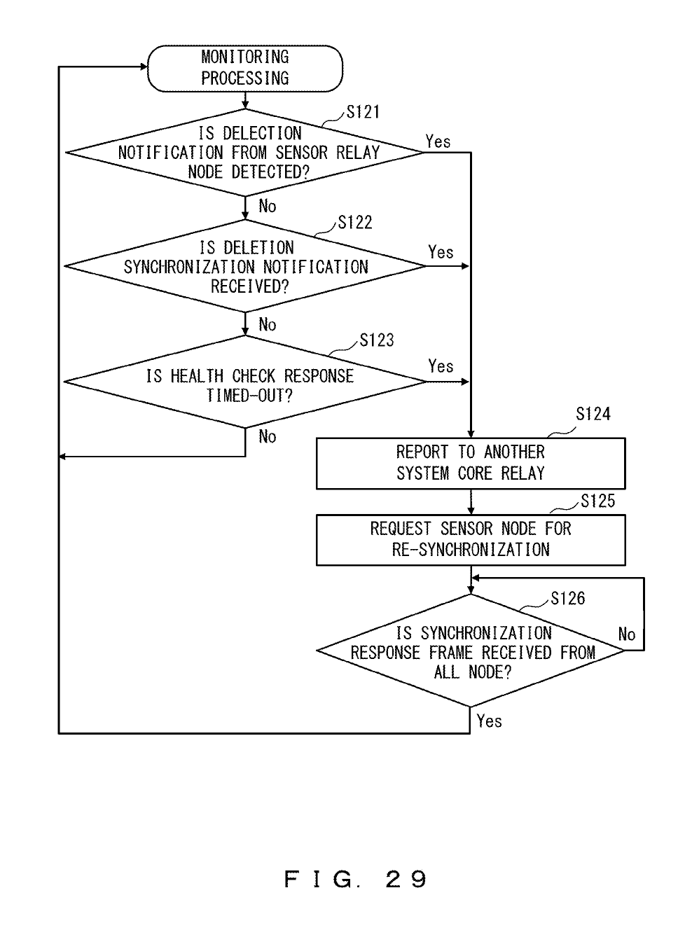

FIG. 29 is a flowchart which explains an example of an operation of a core relay node 50 in a fifth embodiment. The core relay node 50 determines whether or not a deletion notification has been received from the sensor relay node 10 (step S121). When the core relay node 50 has not received the deletion notification, it determines whether or not it received a deletion synchronization notification from another core relay node 50 (step S122). Here, “a deletion synchronization notification” is a control frame which is used for reporting a problem of the sensor relay node 10 to the core relay node 50. The deletion synchronization notification includes an identifier of the sensor relay node 10 in which a problem has occurred. When the core relay node 50 has not received the deletion synchronization notification, it checks whether or not a response of the health frame has timed-out with the sensor relay node 10 that is connected to the core relay node 50 (step S123). When the response of the health frame has not timed-out, the core relay node 50 goes back to step S121 (No in step S123). On the other hand, when Yes is determined in any of steps S121 to S123, the core relay node 50 transmits a deletion synchronization notification to another core relay node 50 (step S124). After that, the core relay node 50 transmits the synchronization request frame to the sensor relay node 10 and makes a request to re-decide the wait number (step S125). The core relay node 50 receives the synchronization response frame from the sensor relay node 10. Further, the core relay node 50 transfers the received synchronization response frame to another core relay node 50 as well. Each core relay node 50 repeats receptions and transfers of a synchronization response frame until it receives the synchronization response frame from all sensor relay nodes 10 that are included in the ad hoc network (step S126). When the core relay node 50 receives the synchronization response frame from all the sensor relay nodes 10, the core relay node 50 repeats processing of step S121 and after (Yes in step S126).

As is explained so far above, when a method according to embodiments is employed, individual pieces of node equipment in the network communicate with each other by using a shortest path.

### Other Embodiments

In the meantime, embodiments are not limited to the above mentioned embodiments and may be modified in many ways. Hereafter, some other examples are stated.

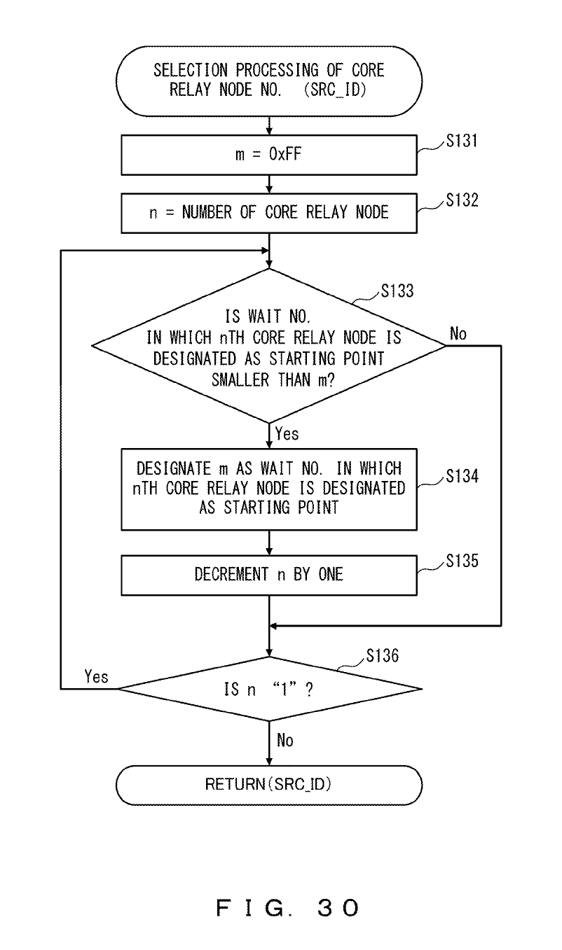

FIG. 30 is a flowchart which explains an example of an operation of a selection unit 35 when selecting a core relay node 50 of a relay destination. The selection unit 35 sets 0xFF as a variable m that indicates a smallest wait number when the wait number in which all core relay nodes 50 in the network are designated as starting points has been decided (step S131). Further, the selection unit 35 sets a total number of the core relay nodes 50 as a variable n for specifying the core relay number that was assigned to the core relay node 50 which is selected as a relay destination (step S132). Next, the selection unit 35 determines whether or not a wait number in which the core relay node 50 of the core relay number=n is designated as a starting point is smaller than m (step S133). When a wait number in which the core relay node 50 of the core relay number=n is designated as a starting point is smaller than m, the selection unit 35 sets the wait number in which the core relay node 50 of the core relay number=n is designated as a starting point as a value of m (step S134). Next, the selection unit 35 decrements a value of n by 1 (step S135). On the other hand, when await number in which the core relay node 50 of the core relay number=n is designated as a starting point is not smaller than m (No in step S133), no processing of steps S134 and S135 is performed. The selection unit 35 repeats processing of steps S83 to S86 until a value of n becomes 1. When the value of n becomes 1, the selection unit 35 selects as a relay destination a core relay node 50 to which a core relay number identical to the value set in n is assigned.

Further, a format of a health frame may be modified as illustrated in F6 of FIG. 7. With the health frame illustrated in F6 of FIG. 7, a wait number may be transmitted one frame at a time, the wait number being one in which each of the plurality of the core relay nodes 50 in the network is designated as a starting point. In this case, a format is decided beforehand such that an order of a wait number in the frame and a core relay node 50 are uniquely correlated.

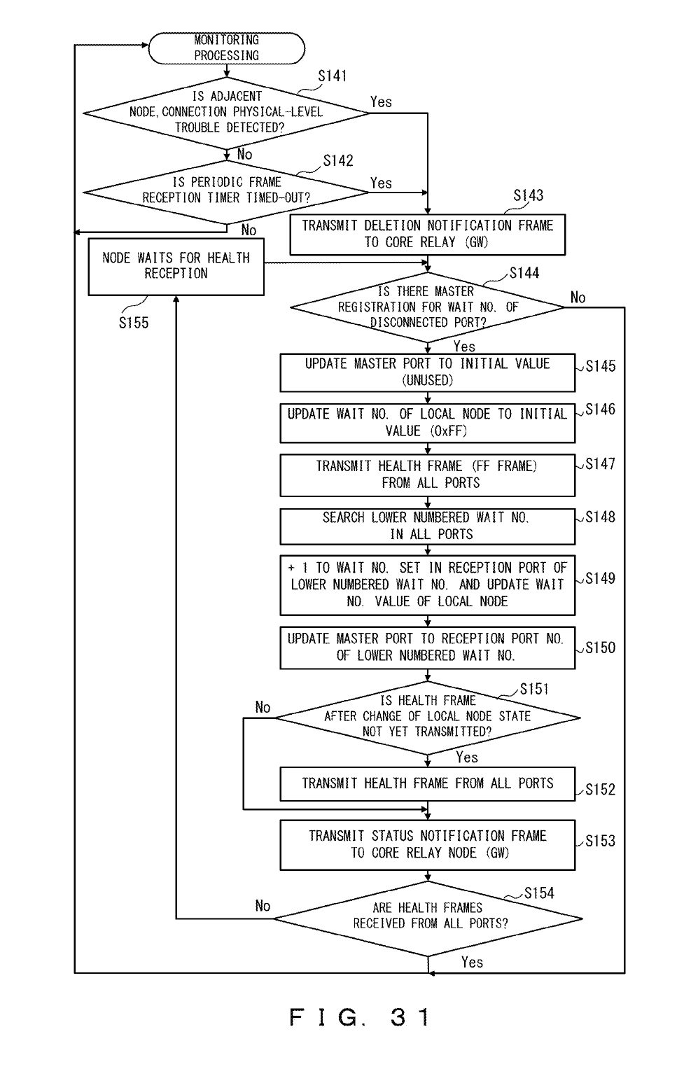

In addition, even when a sensor relay node 10 autonomously changes the wait number, in some cases, the sensor relay node 10 may be modified such that it transmits a deletion request to the a core relay node 50. FIG. 31 is a flowchart which illustrates an example of an operation of a sensor relay node 10. Steps S141 to S143 are similar to steps S111 to S113 for which explanations have been given in reference to FIG. 28. Next, the sensor relay node 10 checks whether the wait number is set, designating as a master port a port from which a problem has been detected (step S144). When a port from which a problem has been detected is a master port, the sensor relay node 10 updates a master port to unused, and further, it updates the wait number of the local node to an initial value (steps S145 and S146). The sensor relay node 10 transmits a health frame from all ports (step S147). Further, by comparing wait numbers of a connection destination connected to each port of the sensor relay node 10, the sensor relay node 10 specifies a port that has a small wait number (step S148). The sensor relay node 10 sets a value in which a wait number of the connection destination of the specified port is incremented by one as a wait number of the local node (step S149). Further, the sensor relay node 10 sets a master port as a port that was specified in step S148 (step S150). The sensor relay node 10, when it has not transmitted a health frame after a status change such as a change of a wait number of the local node, transmits the health frame to the adjacent sensor relay node 10 (steps S151 and S152). In addition, the sensor relay node 10 transmits a status notification frame to a core relay node 50 (step S153). After that, the sensor relay node 10 checks whether or not the health frame was received from all the ports and goes back to step S141 when the reception is completed (Yes in step S154). On the other hand, when the reception of the health frame is not completed, the sensor relay node 10 repeats processing of step S144 and after until it receives the health frame (step S155).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. Node equipment configured to be relayed by a plurality of relay devices to a server in a network, the node equipment comprising:
a receiver configured to receive a frame from adjacent node equipment;
a processor configured to generate a wait number that is generated by incrementing a number of hops for each of the relay devices, when the number of hops to the adjacent node equipment is reported together with a synchronization request from the adjacent node equipment, the number of hops for each of the relay devices being generated by designating each of the plurality of relay devices as a starting point;
a memory configured to store the generated wait number in association with an identifier that identifies the relay device; and
a transmitter configured to transmit a data frame in which the server is designated as an address; wherein
the processor outputs to the transmitter a data frame in which a relay device corresponding to a relatively small wait number stored in the memory is designated as a relay destination.

2. The node equipment according to claim 1, wherein the processor obtains, from a reception frame which was received by the receiver, an address wait number assigned to address node equipment that is an address of the reception frame and an address identifier which identifies a relay device that is designated as a starting point of the address wait number, and performs routing of the reception frame on the basis of a result of comparing a first wait number stored in the storage unit with the address wait number, which the first wait number is associated with the address identifier; and
when the address wait number is larger than the first wait number, the processor determines whether or not the reception frame can be transmitted to adjacent node equipment having a second wait number that is larger than the first wait number stored in the storage unit, the second wait number is generated by designating the relay device identified by the address identifier as a starting point; and
when the reception frame is not transmittable, the processor judges that a loop is detected.

3. The node equipment according to claim 2, wherein when the address wait number is smaller than the first wait number, the processor determines whether or not the reception frame may be transmitted to adjacent node equipment having a third wait number that is smaller than the first wait number stored in the storage unit, the third wait number is generated by designating the relay device identified by the address identifier as a starting point; and
when the reception frame is not transmittable, the processor judges that another loop is detected.

4. The node equipment according to claim 1, wherein the processor
monitors a communication state of adjacent node equipment and detects a communication problem, and
when a communication problem is detected, changes to an initial value a generated wait number generated by using a synchronization request received from an adjacent node from which the communication problem has been detected, and
selects, from among relay devices in which an associated generated number is not the initial value, a relay device having an associated generated wait number that is relatively small.

5. The node equipment according to claim 4, comprising a plurality of network ports, wherein
the memory, for each of a plurality of pieces of adjacent node equipment connected via one of the plurality of network ports, an adjacent wait number is recorded in association with an identifier which identifies a relay device designated as a starting point when counting a number of hops that is used for generating the adjacent wait number and in association with a number of a network port which received a frame including the adjacent wait number, the adjacent wait number being a wait number generated in each of the plurality of adjacent nodes,
the processor, when it has detected a communication problem, generates a frame that makes a request to initialize a wait number designating a first relay device as a starting point, the request being made from a port having an adjacent wait number that is larger than a generated wait number in which the first relay device is designated as a starting point, the adjacent wait number is generated by the adjacent node equipment which has not generated the communication problem and when the adjacent wait number is generated the first relay device is designated as a starting point; and
the transmitter transmits a frame which makes a request for the initialization.

6. The node equipment according to claim 5, wherein the processor, when it is reported that a communication problem has occurred between a first relay device from among the plurality of relay devices and the server, generates a frame which requests the adjacent node equipment to initialize a wait number associated with the first relay device, and initializes a wait number associated with the first relay device.

7. A method for communication by second node equipment which is adjacent to first node equipment, the second node equipment belonging to a network and being configured to be relayed by a plurality of relay devices with a server that is a data address, the method comprising:
obtaining a first wait number which is a number of hops from a first relay device from among the plurality of relay devices to a first node equipment from the first node equipment together with a synchronization request;
generating a second wait number by incrementing the first wait number;
storing the second wait number in association with a first identifier which identifies the first relay device;
obtaining a third wait number with a synchronization request from a third node equipment, the third wait number being a number of hops from a second relay device from among the plurality of relay devices to the third node equipment which is adjacent to the second node equipment;
generating a fourth wait number by incrementing the third wait number;
storing the fourth wait number in association with a second identifier which identifies the second relay device; and
when the second wait number is smaller than the fourth wait number, the second node equipment designates the first relay device as a relay destination and transmits a data frame to the server.

8. The method for communication according to claim 7, wherein the first node equipment
obtains from fourth node equipment a fifth wait number that is a number of hops from the first relay device to the fourth node equipment which is adjacent to the first node equipment,
compares the first wait number with the fifth wait number when the first node equipment receives the data frame from the second node equipment, and
transfers the data frame to the fourth node equipment when the fifth wait number is smaller than the first wait number.

9. The method for communication according to claim 8, wherein
the first node equipment transmits the data frame to the second node equipment when a data frame received from the second node equipment is not transmittable to node equipment having a number of hops smaller than the first wait number, the number of hops is generated by designating the first relay device as a starting point, and
the second node equipment sets as a loop state a state of a port connected to the first node equipment in association with a frame designating the server as an address.

10. The method for communication according to claim 7, wherein
when a communication problem occurs between the first relay device and the server, the first relay device broadcasts an initialization frame requesting to initialize await number calculated by using a number of hops in which the first relay device is designated as a starting point, and
when the second node equipment receives the initialization frame, the second node equipment sets the second wait number as an initial value, and,
the second node equipment does not designate the first relay device as a relay destination of a frame to the server.

11. The method for communication according to claim 7, wherein
the second node equipment, when requesting a synchronization to the third node equipment, reports the second wait number and the first identifier to the third node equipment,
the third node equipment stores a sixth wait number obtained by incrementing the second wait number, and associates the sixth wait number with the first identifier,
when a problem occurs in the second node equipment, the third node equipment compares the second wait number with the sixth wait number,
when the sixth wait number is larger than the second wait number, the third node equipment initializes the sixth wait number, and
the third node equipment does not designate the first relay device as a relay destination when transmitting a frame to the server.

12. The method for communication according to claim 7, wherein,
when a communication problem occurs in the first node equipment, the second node equipment reports to the first relay device that the communication problem has occurred in the first node equipment,
the first relay device reports to the second relay device that the communication problem has occurred in the first node equipment,
the first relay device broadcasts a frame which makes a request to recalculate a wait number calculated by using a number of hops in which the first relay device is designated as a starting point,
the second relay device broadcasts a frame which makes a request to recalculate a wait number calculated by using a number of hops in which the second relay device is designated as a starting point, and
the second node equipment decides a relay destination of a communication with the server by using a newly calculated wait number.
